(19) United States
(12) Patent Application Publication
(10) Pub. No.: US 2016/0378549 A1
(43) Pub. Date: Dec. 29, 2016

(54) Goal-Oriented, Socially-Connected, Task-Based, Incentivized To-Do List Application System and Method

(71) Applicant: Qwest.me, LLC, Pflugerville, TX (US)

(72) Inventor: James Michael Irish, Pflugerville, TX (US)

(73) Assignee: Qwest.me, LLC, Pflugerville, TX (US)

(21) Appl. No.: 15/189,791

(22) Filed: Jun. 22, 2016

Related U.S. Application Data
(60) Provisional application No. 62/183,306, filed on Jun. 23, 2015.

(51) Int. Cl. G06F 9/48; H04L 29/08; G06F 3/0484

(52) U.S. Cl. CPC G06F 9/4881; G06F 3/0484; H04L 67/1002

(57) ABSTRACT

A system may provide a socially connected application for managing a list of tasks, assignable by one or more assignors to be performed by one or more assignees. The method may provide a multi-platform application, including a method when executed on a processor include receiving a plurality of tasks to be performed, tracking completion, and tracking points associated with successful completion. Tasks may be assigned and confirmed completed by assignors, and performed by assignees. The system may include a point value system enabling redemption upon completion of tasks having point value or currency value. The point reward system may be integrated with other technologies to facilitate transfer of exemplary fiat or crypto currency, loyalty program points, desired product purchases on behalf of the assignee or other benefit. The method may include: receiving, by processor, a plurality of tasks; and managing, a point system associated with completion of each task. The system may provide instructional steps of how to perform a task. The system may provide proof of accomplishment, initiation, or completion of a task by the assignees to the assignors. The system may provide a listing of tasks for users to sign up for task assignments in return for a specified bounty. The system may receive and/or provide an assessment of the completed task by the assignors.

### CROSS-REFERENCE TO RELATED APPLICATIONS

This application claims priority to Provisional Patent Application No. 62/183,306, filed Jun. 23, 2015, which is hereby incorporated by reference in its entirety.

### FIELD OF THE INVENTION

The present invention relates generally to rewards, and more specifically, incentivizing individuals or groups for tasks completed set by another party or parties and agreed upon by both the assignors and assignees.

### BACKGROUND OF THE INVENTION

Conventionally, various systems have existed for managing a user's time. A task list is a conventional time management tool.

Time management is the act or process of planning and exercising conscious control over the amount of time spent on specific activities, especially to increase effectiveness, efficiency and/or productivity. Time management may be aided by a range of skills, tools, and techniques used to manage time when accomplishing specific tasks, projects and goals complying with a due date. This set encompasses a wide scope of activities, and these include planning, allocating, setting goals, delegation, analysis of time spent, monitoring, organizing, scheduling, and prioritizing.

Initially, time management referred to just business or work activities, but eventually the term broadened to include personal activities as well. A time management system is a designed combination of processes, tools, techniques, and methods. Usually time management is a necessity in any project development as it determines the project completion time and scope.

A task list (also to-do list or things-to-do) is a list of tasks to be completed, such as chores or steps toward completing a project. The task list is an inventory tool which serves as an alternative or supplement to memory.

Task lists are used in self-management, grocery lists, business management, project management, and software development. Task lists may involve more than one list.

When one of the items on a task list is accomplished, the task is normally checked or crossed off. The traditional method is to write these on a piece of paper with a pen or pencil, usually on a note pad or clip-board.

Numerous digital equivalents are now available, including personal information management (PIM) applications and most personal digital assistants (PDAs). There are also several web-based task list applications, many of which are free.

Personal Information Managers (PIMs)

A personal information manager (PIM) (often referred to as a PIM tool or, more simply, a PIM) is a type of application software that functions as a personal organizer. The acronym PIM is now, more commonly, used in reference to personal information management as a field of study. As an information management tool, a PIM tool's purpose is to facilitate the recording, tracking, and management of certain types of “personal information.” PIMs are often used to track personal information, which can include any of the following: personal file collections (e.g., digital and physical documents, music, photos, videos, etc.), personal notes/journal entries, address books, lists (including task lists), significant calendar dates birthdays, anniversaries, appointments and meetings, reminders, electronic mail (email), instant messages (IMs), fax communications, voicemail, project management features, real simple syndication (RSS) feeds, etc., alerts, references (including scientific references, websites of interest), etc.

In recent times, time management and communications functions of PIMs have largely migrated from PDAs to smartphones, with RIM (Research In Motion), Apple (iPhone, iPad, etc.), Google (Android based devices such as the Samsung Galaxy S3, etc.) and others all manufacturing smartphones that offer most if not all of the functions of earlier PDAs. The convergence of many communications technologies, including telephone, email, social media, news and journalism, and radio transmission, in a compact, ubiquitous device, along with the ability of these devices to create, transmit and publish voice, text, photos, and video almost instantaneously is a development that many social commentators expect will revolutionize the way humans interact with each other, and with government and media.

Task List Organization

Task lists are often tiered. The simplest tiered system may include a general to-do list (or task-holding file) to record all the tasks the person needs to accomplish, and a daily to-do list which is created each day by transferring tasks from the general to-do list. Task lists are often prioritized.

For example, an early advocate of “ABC” prioritization was Alan Lakein. In his system “A” items were the most important (“A-1” the most important within that group), “B” next most important, “C” least important. A particular method of applying the ABC method assigns “A” to tasks to be done within a day, “B” a week, and “C” a month. To prioritize a daily task list, one either records the tasks in the order of highest priority, or assigns them a number after they are listed (“1” for highest priority, “2” for second highest priority, etc.) which indicates in which order to execute the tasks. The latter method is generally faster, allowing the tasks to be recorded more quickly. Another way of prioritizing compulsory tasks (group A) is to put the most unpleasant one first. When it's done, the rest of the list feels easier. Groups B and C can benefit from the same idea, but instead of doing the first task (which is the most unpleasant) right away, it gives motivation to do other tasks from the list to avoid the first one.

A completely different approach which argues against prioritizing altogether was put forward by British author Mark Forster in his book “Do It Tomorrow and Other Secrets of Time Management.” This is based on the idea of operating “closed” to-do lists, instead of the traditional “open” to-do list. He argues that the traditional never-ending to-do lists virtually guarantees that some of your work will be left undone. This approach advocates getting all your work done, every day, and if you are unable to achieve it helps you diagnose where you are going wrong and what needs to change.

Various writers have stressed potential difficulties with to-do lists.

Management of the list can take over from implementing it. This could be caused by procrastination by prolonging the planning activity. This is akin to analysis paralysis. As with any activity, there's a point of diminishing returns.

Some level of detail must be taken for granted for a task system to work. Rather than put “clean the kitchen,” “clean the bedroom,” and “clean the bathroom,” it is more efficient to put “housekeeping” and save time spent writing and reduce the system's administrative load (each task entered into the system generates a cost in time and effort to manage it, aside from the execution of the task). The risk of consolidating tasks, however, is that “housekeeping” in this example may prove overwhelming or nebulously defined, which will either increase the risk of procrastination, or a mismanaged project.

Listing routine tasks wastes time. If you are in the habit of brushing your teeth every day, then there is no reason to put it down on the task list. The same goes for getting out of bed, fixing meals, etc. If you need to track routine tasks, then a standard list or chart may be useful, to avoid the procedure of manually listing these items over and over.

To remain flexible, a task system must allow for disaster. An entity must be ready for a disaster. Even if it is a small disaster, if no one made time for this situation, it can metastasize, potentially causing damage to the entity.

To avoid getting stuck in a wasteful pattern, the task system should also include regular (monthly, semi-annual, and annual) planning and system-evaluation sessions, to weed out inefficiencies and ensure the user is headed in the direction he or she truly desires.

If some time is not regularly spent on achieving long-range goals, the individual may get stuck in a perpetual holding pattern on short-term plans, like staying at a particular job much longer than originally planned. To mitigate this, small milestones on a large task should be reported and optionally approved or scored towards points towards that large task completion. Further mitigation techniques include time-outs that warn assignors that they might need to check in and follow up if there are any problems, and features to allow assignees to report problems encountered during task-completion attempts.

Software Applications

Modern task list applications may have built-in task hierarchy (tasks are composed of subtasks which again may contain subtasks), may support multiple methods of filtering and ordering the list of tasks, and may allow one to associate arbitrarily long notes for each task.

In contrast to the concept of allowing the person to use multiple filtering methods, at least one new software product additionally contains a mode where the software attempts to dynamically determine the best tasks for any given moment.

Many of the software products for time management support multiple users. They allow the person to give tasks to other users and use the software for communication

In law firms, for example, law practice management software may also assist in time management.

Task list applications may be thought of as lightweight personal information manager or project management software.

Conventional task list methods and systems have various shortcomings. What is needed is an improved system and method that overcomes the various shortcomings of conventional solutions.

### BRIEF SUMMARY OF THE INVENTION

Various exemplary embodiments of a system, method, and computer program product for providing a merit-based incentive to-do list application is set forth in detail herein.

According to one exemplary embodiment, a computer implemented method, system, and/or computer program product executable on a computer processor may include an exemplary applet based to-do list application.

According to one exemplary embodiment, a computer implemented system, method and/or computer program product may provide an application for managing a to-do list of activities assignable by an assigning user and performable by a performing user.

The method, according to one exemplary embodiment, may provide a multi-platform application, which may include a method, when executed on a computer processor, may include receiving a plurality of tasks to be performed, tracking completion of the plurality of tasks, and tracking points associated with successful completion of the plurality of tasks.

In one exemplary embodiment, the plurality of tasks may be assigned by the assigning user and the plurality of tasks may be performed by the performing user.

According to one exemplary embodiment, the system may include an exemplary reward system. According to one exemplary embodiment, the reward system may be adapted to be integrated with other technologies to dispense exemplary currency and/or benefits associated with the reward system.

According to an exemplary embodiment, a computer-implemented method may include: receiving, by at least one computer processor, a plurality of tasks, wherein each of said plurality of tasks is assigned by an assignor to be performed by an assignee; and managing, by the at least one computer processor, a point system associated with completion of said plurality of tasks.

According to one exemplary embodiment, the method may include: wherein the assignor comprises at least one of: a guardian, a boss, or a parent, and wherein the assignee comprises at least one of: a dependent, an employee, or a child.

According to one exemplary embodiment, the method may include: wherein said receiving said plurality of said tasks comprises at least one of: receiving, by the at least one computer processor, a numeric value associated with task and receiving, by the at least one computer processor, data about each task of said plurality of tasks.

According to one exemplary embodiment, the method may include: wherein said managing comprises at least one of: maintaining, by the at least one computer processor, a point balance associated with each assignee; receiving, by the at least one computer processor, at least one indication of an adjustment to said point balance comprising at least one of: receiving, by the at least one computer processor, at least one point value adjustment associated with at least one assignee, upon completion of at least one task of said plurality of tasks; and receiving, by the at least one computer processor, an adjustment to said point balance comprising at least one of: at least one indication of at least one credit to the balance of at least one assignee; at least one indication of at least one debit to the balance of at least one assignee; and storing, by the at least one computer processor, said point balance.

According to one exemplary embodiment, the method may further include: receiving, by the at least one computer processor, a request to transfer at least a portion of points of said point system.

According to one exemplary embodiment, the method may include: wherein said receiving said request to transfer points comprises at least one of: receiving, by the at least one computer processor, a request to exchange points for a wish list item, receiving, by the at least one computer processor, a request to gift points by a first assignee to second assignee, receiving, by the at least one computer processor, a request to gift points within a group or family; receiving, by the at least one computer processor, a request to buy intragroup or intrafamily value goods or services; receiving, by the at least one computer processor, a request to trade points within a group or family for a value; and receiving, by the at least one computer processor, a request to convert at least a portion of said point system value to a monetary spend equivalent value comprising at least one of: receiving, by the at least one computer processor, a request to convert at least a portion of said point system value into a gift card value; receiving, by the at least one computer processor, a request to convert at least a portion of said point system value into a third party payer equivalent value; and receiving, by the at least one computer processor, a request to convert at least a portion of said point system value into at least one of: a prepaid online account value, a prepaid account value, a merchant account value, a merchant account bank card value, a merchant account debit card value, and a merchant account charge or credit card value.

According to one exemplary embodiment, the method may include: wherein said receiving said request to transfer comprises: receiving a request to transfer at least a portion of said point system value for at least one of: an intragroup good or service and an intrafamily good or service.

According to one exemplary embodiment, the method may include: wherein said intragroup or said intrafamily goods or services comprise at least one of: a chore, a communication device, a computing device, a networked device, a wireless network device, a gaming device, a time period or duration of use of a communication device, a time period or duration of use of a computing device, a time period or duration of use of a networked device, a time period or duration of use of a wireless network device, a time period or duration of use of a gaming device, time period or duration with a toy, a time period or duration of use of with a screen device, a time period or duration of use of with a device, a time period or duration of use of with a friend, a time period or duration of use of with a parent, a time period or duration of use of with an individual, a time period or duration of use of with a group, and a time period or duration of use of with a tool.

According to one exemplary embodiment, the method may further include: receiving, by the at least one computer processor, a request to receive in a table an indication of a point value associated with a given task.

According to one exemplary embodiment, the method may further include: communicating with a third party comprising at least one of a partner, a provider, a vendor, a merchant, an advertiser, and an assignor; wherein said communicating comprising at least one of: providing access by the third party to at least one of: at least one wish list; at least one point balance; at least one relevant task; at least one wish list of the assignee; at least one point balance of the assignee; at least one relevant task of the assignee; at least one wish list of the assignor; at least one point balance of the assignor; at least one relevant task of the assignor; at least one wish list of the third party; at least one point balance of the third party; and at least one relevant task of the third party; receiving instructional content; receiving instructional content on how to perform an associated task; receiving instructional content from the third party; receiving instructional content from an assignor; receiving instructional content from another assignor; receiving a request to transfer at least a portion of a point system value; receiving a request to transfer at least a portion of a point system value in exchange for a 3P partner value; receiving a request to transfer at least a portion of a point system value into an online commerce company gift card value; and receiving at least one of: a coupon, an offer, a deal, a bid, and discount from at least one of: a merchant, an online merchant, an offline merchant, and a 3rd party online partner.

According to one exemplary embodiment, receiving an instructional video may include, but is not limited to, a video instructing an individual how to brush teeth, etc.

According to one exemplary embodiment, the method may include: wherein said receiving said plurality of tasks comprises: receiving a request to create at least one of said plurality of tasks.

According to one exemplary embodiment, the method may include: wherein said receiving a plurality of tasks comprises: receiving a request to create at least one task comprising at least one: receiving a request to receive or capture content of a given task comprising at least one of: media, multiple content, image, video, audio, multimedia, text, hyper text, file, text instructions, and picture; receiving a request to receive or capture content of proof of completion of a given task comprising at least one of: receiving a request to authenticate comprising capturing proof of completion by the assignee or the assignor; receiving a request to verify by the assignee or the assignor; receiving a request to acknowledge completion by the assignee or the assignor; or receiving a request to confirm by the assignee or the assignor; and receiving a request to receive or capture at least one instruction related to a given task, comprising at least one of: capturing from at least one of: the assignor or another assignor; and capturing from a third party comprising at least one of: an assignor, another assignor, and a vendor.

According to one exemplary embodiment, the method may further include: receiving a request to convert at least a portion of accumulated point system value into a monetary value, and further comprising: providing at least one of: providing at least one controlled account with preauthorization rules of restrictions for usage of said monetary value and providing at least one non-controlled account with no restrictions on use.

According to one exemplary embodiment, the method may include: wherein said receiving a plurality of tasks comprises: receiving a request to assign at least one task by the assignor to at least one assignee of said plurality of assignees comprising: receiving a request to assign the at least one task to a plurality of assigned assignees of said plurality of assignees comprising at least one of: receiving a request to capture which at least one assigned assignee of a plurality of assignees are assigned to the at least one task; receiving a request to capture or assign at least one of said plurality of assigned assignees assigned as task leader of said plurality of assigned assignees; and receiving a proportional division of points for each of said plurality of assigned assignees.

According to one exemplary embodiment, the method may further include: receiving a request to capture comprising at least one of: receiving a request to capture at least one positive action and receiving a request to capture at least one negative action.

According to one exemplary embodiment, the method may include: wherein said at least one negative action comprises at least one of: receiving a request to capture at least one habitual action or a list of habitual action or unwanted behavior by at least one offending assignee and to associate a negative point value to each of said at least one habitual action; receiving a request to capture from the assignor at least one specific instance of said at least one habitual action or unwanted behavior, or any item on the list of habitual action or unwanted behavior; receiving a request to capture evidence of at least one instance of said at least one habitual action or unwanted behavior through at least one form of content comprising at least one of: a media, a multiple content, an image, a video, an audio, a multimedia, a text, a hyper text, a file, a text instruction, a picture, a voice, receiving a request to deduct the associated negative point value from the offending assignee; and receiving a request to notify the offending assignee of a specific instance of said at least one habitual action or unwanted behavior and the associated negative point value.

According to one exemplary embodiment, the method may include: wherein said receiving a request to capture of at least one positive action by assignees comprises at least one of: receiving a request to capture an ad hoc or other observation of performance of an instance of a positive, non-assigned task by an assignee; receiving a request to capture an observation of an instance of a positive action of the assignee that demonstrates a behavior of deserved merit; receiving a request to deposit points, or depositing in a points system account of the assignee of a points system value received from the assignor; and receiving a request to notify or notifying the assignee of the specific instance of positive behavior and the points system value received by the assignor.

According to one exemplary embodiment, the method may further include: receiving a request to modify points system value for a given task comprising at least one of: receiving a base point value for said given task; receiving rules that may modify the base point value for said given task; storing rules in at least one database table; comparing rules with the outcome of the task; calculating a modification to the baseline point value for said given task; displaying the modified point value for said given task to at least one of the assignee or assignor; receiving an adjustment of the assignor to the base or modified point value of said given task of the assignee resulting in the final point value of said given task; and depositing the final point value of said given task in the points value system account of the assignee.

In one exemplary embodiment, comparing rules may include comparing whether performance of the task was completed before, by, or after a task deadline, etc.

According to one exemplary embodiment, the method may further include: receiving or providing a status of a given task comprising at least one of: receiving or providing a current status of at least one or all tasks; comparing the status of at least one or all tasks with a table of at least one rule; performing at least one calculation based on at least one rule; capturing at least one time stamp; measuring time between at least two time stamps of a status change of at least one task; displaying at least one message; and sending at least one reminder or alert based on at least one rule associated with the status.

According to an exemplary embodiment, a system comprising: at least one memory; and at least one processor coupled to said at least one memory, wherein said at least one processor is adapted to: receive a plurality of tasks, wherein each of said plurality of tasks is assigned by an assignor to be performed by an assignee; and manage a point system associated with completion of said plurality of tasks.

According to an exemplary embodiment, a computer program product embodied on a computer accessible medium, comprising program logic, which when said program logic is executed on at least one computer processor, performs a method comprising: receiving, by at least one computer processor, a plurality of tasks, wherein each of said plurality of tasks is assigned by an assignor to be performed by an assignee; and managing, by the at least one computer processor, a point system associated with completion of said plurality of tasks.

Further features and advantages of the disclosure, as well as the structure and operation of various exemplary embodiments of the disclosure, are described in detail below with reference to the accompanying drawings.

### BRIEF DESCRIPTION OF THE DRAWINGS

The foregoing and other features and advantages of the disclosure will be apparent from the following, more particular description of embodiments of the disclosure, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a heterogeneous client device environment coupled to an exemplary network system adapted to provide a merit-based incentive to-do list application system architecture environment using a plurality of computing and/or communication devices coupled together in a distributed networked system architecture;

FIG. 2 depicts an exemplary embodiment of a network-based, merit-based incentive, to-do list application system architecture diagram coupled by an exemplary cloud-based architecture network;

FIG. 3 depicts an exemplary embodiment of a system illustrating an exemplary distributed user and service provider network environment;

FIG. 4 depicts an exemplary embodiment of a system illustrating an exemplary distributed network environment;

FIG. 5 depicts a wireframe model of an exemplary user interface (UI) illustrating an exemplary to-do list application program for managing and tracking an exemplary list of a plurality of tasks (e.g., previously assigned by an exemplary assigning user or assignor, e.g., but not limited to, a parent) to be performed by a performing user or assignee (e.g., but not limited to, a child, etc.);

FIG. 6 depicts an exemplary flow diagram illustrating an exemplary computer implemented process for managing completion of a list of tasks assigned to a performing user by an assigning user;

FIG. 7 depicts an exemplary flow diagram illustrating an exemplary computer implemented process for creating a task list and/or one or more rewards by an assigning user;

FIG. 8 depicts a wireframe model of an exemplary user interface (UI) illustrating an exemplary application program for displaying an exemplary current balance of points for an exemplary points value system; and an exemplary interface for viewing the task-completed and penalty transactions that total to obtain that final point value;

FIG. 9 depicts a wireframe model of an exemplary user interface (UI) illustrating an exemplary application program for displaying completed tasks with their associated bounty in karma points, a karma point balance, a karma-point-to-currency exchange rate, and an exemplary interface for redeeming accumulated currency or converted karma points;

FIG. 10 depicts a sequence diagram of an exemplary online retail “EarnNow” button pressed during checkout; in the diagram, the retail system (here, “Consumer”) of the “EarnNow system” transfers the user of the EarnNow system for authentication, which is then processed, validated, and transferred back to the retail system;

FIG. 11 depicts an exemplary entity diagram of an exemplary stored-value-account (“SVA”) system architecture used for transferring bank or credit card funds into a donor's SVA system account, transferring funds between SVA accounts, and transferring funds from a beneficiary's SVA account into a bank account, gift card, or pre-paid debit card;

FIG. 12 depicts a sequence diagram of an exemplary SVA system, summarizing the operations of loading funds into an SVA account from a bank, transferring funds between SVA accounts, and unloading funds from an SVA account to a bank; and

FIG. 13 depicts an exemplary diagram illustrating an exemplary computer/communications device hardware architecture as may be used in various components of exemplary embodiments of the present disclosure.

FIG. 14 displays a system for managing a plurality of assignable tasks in accordance with embodiments.

FIG. 15 displays a computer implemented method for managing a plurality of assignable tasks in accordance with embodiments.

### DETAILED DESCRIPTION OF ILLUSTRATIVE EMBODIMENTS

Various exemplary embodiments of the invention are discussed in detail below. While specific exemplary embodiments are discussed, it should be understood that this is done for illustration purposes only. Exemplary means example for purposes of this application, and various embodiments need not include all features as described herein. A person skilled in the relevant art will recognize that other components and configurations can be used without parting from the spirit and scope of the invention.

### Overview of Exemplary Embodiments

According to an exemplary embodiment, a task assigning user (e.g., but not limited to, a parent) may face several challenges in getting a performing user (e.g., but not limited to, a child, or teenager) to complete a group of assigned tasks. Often, communication of the tasks is inadequate, and inadequate recollection of the tasks by the performing user, can lead to a failure of the performing user completing tasks as assigned. According to one exemplary embodiment, a novel, nonobvious approach to assigning and managing tasks to be performed by another user is provided.

In an exemplary embodiment, an improved system, method and/or computer program product may be provided to manage the task of assigning tasks, managing completion of the tasks, and creating and managing a merit-based incentive system to encourage completion of the tasks, and to provide a reward system to help reach the goals of the assigning user assigning tasks to the performing user.

According to an exemplary embodiment, one or more exemplary apparatus(es), device(s), method(s), and/or business method(s) are set forth, which may be used by an exemplary assigning user such as, e.g., but not limited to, a parent, a manager, an employer, a supervisor, a superior, etc., to assign one or more tasks to an exemplary performing user such as, e.g., but not limited to, a child, a teenager, an employee, a rank, and file member, etc. to manage assignment, completion and an incentive/reward system, according to an exemplary embodiment.

According to an exemplary embodiment, the method may include receiving, from the assigning user, a list of one or more tasks, associating the tasks with a given task list or to-do list, managing tracking of completion of the task list by the performing user, and managing an incentive reward system for driving completion of the assigned tasks.

According to an exemplary embodiment, a given completed task may result in a reward currency or other benefit being generated and/or earned, and access to the currency may be metered out to the performing user via any of several exemplary methods.

In one exemplary embodiment, technology aids may be coupled to the reward system to enable an integrated system to access reward and/or benefit via exemplary electronic access. One exemplary embodiment of the invention may include receiving any authorization of an individual's payment method (such as, e.g., but not limited to, a credit card) for a monetary amount (i.e. price) of the current tier a multi-tier thread is at, followed by the charging of the variable amount (tier) the thread may reach upon expiration of the dynamic countdown generated by the first buyer (creator) of the thread.

One exemplary embodiment of the disclosure may include tracking of a non-monetary indicia of task completion. An exemplary point system, referred to, in an exemplary embodiment as so-called Karma points, may enable creating a benefit currency that may be redeemed in any of various exemplary methods.

One exemplary embodiment of the disclosure may include allowing the assignee(s) to enter personal goal rewards into the system. Exemplary goal rewards may include products for retail purchase, such as a bicycle from Toys-R-Us. These goal rewards are accumulated in the form of an exemplary “wish list”. Goal rewards may be entered into the system via an exemplary browser plugin used at online retailers, an “EarnNow” button on the checkout page of a retail partner, a dedicated “reward shop” similar to a frequent flier miles reward program product catalog, a mobile “app” that scans retail product bar codes or QR codes for entry into the system, or any of a number of other means.

According to one exemplary embodiment, an exemplary EarnNow system including tasks accomplished or goals earned by individuals or groups may be published on their respective timelines on social media.

One exemplary embodiment of the disclosure may include methods by which tasks and associated bounties, in currency, points, or other form, can be posted to a list by users of the system for completion in return for that bounty by other users.

Exemplary Parent-Child Environment

According to one exemplary, but non-limiting environment, an exemplary EarnNow system, method and/or computer program product may be used by an exemplary parent to achieve getting the parent's kids to “get their stuff done, without all the nagging.”

Orders and reminders may be given to children that may include, but is not limited to, clean up after a meal, pick up a wet towel, make their bed, empty the dishwasher, and put away their clean laundry, etc. Kids may be given treats when they do good things and may be disciplined when children do bad things. The good and bad behavior change in children may be continuous. The disclosure may provide a system that may control, process, and automate rewards and punishments for children.

According to one exemplary embodiment, a system, method, and/or computer program product for enabling task assignment and completion management may be designed to aid in an automated interactive application tailored to facilitate management of child rearing task completion, which may include an award redemption tool.

According to one exemplary embodiment, the system, method, and/or computer program product may each be referred to as an “EarnNow service.”

A number of “to-do” apps may be available. However, with all the many to-do list application programs conventionally available, none are made specifically to teach children the right way to get a task done, to reward children accordingly, to discipline children accordingly, and to take the chaos and exasperation by the parents out of getting the tasks completed by the kid.

An exemplary EarnNow service may include a multi-platform app, or application program, or applet, which may enable parents to create tasks, assign them to the parents' children with instructions, deadlines, and quality expectations.

According to an exemplary embodiment, children may receive exemplary tasks, which may be made to appear on the electronic devices of the child (e.g., but not limited to, on an iPod, an iPod Touch, an iPhone, an Android device, a Mac, a PC, a tablet, an iPad, a smart television, a smart device, a smart car, a smart appliance, a notebook, a computer, a communications device, a mobile phone w/text, a smartphone, a personal digital assistant (PDA), a mobile phone, an Internet browser application, a standalone application, a set top box, a television receiver, a smart television, and/or any of various exemplary but not limiting devices, etc.), which may update the status of the child's assigned tasks (e.g., but not limited to, in-progress, completion, pictures, etc.).

According to an exemplary embodiment, parents may receive task updates on their electronic devices (e.g., see childrens' devices) where they can choose to inspect the progress of the task work to date, the quality of the completed task, and/or rely on the child's assessment and picture.

Exemplary Crowd-Sourced Task-List Creation and Crowd-Funded Task-List Rewards

According to one exemplary embodiment, an exemplary system, method and/or computer program product may be used by an exemplary donor group to allow an exemplary beneficiary group (such as a church group or club) to earn money for a group trip. Similar to the previous exemplars, the goals may be determined by the assignees, the tasks may be set by the donor group members (assignors), the tasks may be agreed to be completed by the beneficiary (task assignee) group members, point or monetary values for tasks may be agreed upon, and conversion rates for points to currency may be agreed upon. As tasks are verified as being completed, points may accrue for the beneficiary for later redemption in currency, goal items, or other benefit.

The parents of a church teen group may be delighted to have the opportunity to donate to a group trip. Parents may feel better about the entire process if they can give the members of the teen group the sense that they have “earned it”. According to one exemplary embodiment, a system may provide a socially-connected (taking advantage of social media for group coordination and social recognition), goal-driven (the beneficiaries are seeking a large group outcome), task-oriented (several small tasks accrue points, currency or other benefit towards the larger goal) application. This exemplar may be considered a merger of the concepts of “crowd-sourcing” sets of tasks and “crowd-funding” goals.

According to one exemplary embodiment, a system, method, and/or computer program product may enable task assignment and completion management designed to aid an automated interactive application tailored to facilitate management of group task creation and assignment, group reward upon completion, and reward redemption.

There exist many project management tools available to a centralized enterprise, but nothing to allow crowd-sourcing of tasks or milestones from multiple assignors to multiple assignees, especially when a group of assignors or assignees may not be identified in advance at the start of any particular project or goal to be reached.

An exemplary service may include a multi-platform app, application program, or applet, which may enable donor group members to create tasks, assign them to the beneficiary group with instructions, deadlines, and quality expectations.

According to an exemplary embodiment, beneficiary group members may receive exemplary tasks, which may be made to appear, by the exemplary system, on the electronic devices of the beneficiary group member (e.g., but not limited to, on an iPod, an iPod Touch, an iPhone, an Android device, a Mac, a PC, a tablet, an iPad, a smart television, a smart device, a smart car, a smart appliance, a notebook, a computer, a communications device, a mobile phone w/text, a smartphone, a personal digital assistant (PDA), a mobile phone, an Internet browser application, a standalone application, a set top box, a television receiver, a smart television, and/or any of various exemplary but not limiting devices, etc.) and may additionally update the status of the beneficiary group member's assigned tasks (e.g., but not limited to, in-progress, complete, take a picture, etc.).

According to an exemplary embodiment, donors may receive task updates on their electronic devices (e.g., as described above with reference to beneficiary group members' devices), where they can choose to inspect the quality of the completed task or rely on the beneficiary group members' assessment and picture.

Karma Points

According to an exemplary embodiment, a parent (or other assignor) can then issue Karma Points (or other exemplary point system value) to the child's (or other assignee's) account, which can be saved and, e.g., but not limited to, be exchanged for exemplary valuable benefit such as, e.g., but not limited to, conversion to money, time, activities, and tangible rewards such as unlock codes for game systems, (e.g. XBOX), online gift cards, money, movie tickets, Daddy Date, slumber party, or anything else with which a parent would desire to reward good behavior. Alternatively, Karma Points, according to an exemplary embodiment, can be reduced for task deadlines that are missed, for poor quality work (e.g. jamming their clothes under the bed instead of hanging them in a closet), or for bad behavior (talking back, swearing, fighting, bad grades, lying, etc), all of which can be customized by the parent.

According to an exemplary embodiment, tasks can be pulled from a pre-made list, or created from scratch, which may allow the parent to modify variables such as, e.g., but not limited to, due date, periodicity, quality, task owner(s), and/or Karma Level (what the task is worth), etc. Additionally, according to an exemplary embodiment, “repeat offenders” can be called up from a quick list so parents can quickly note an issue.

An example, according to an exemplary embodiment, may include, but is not limited to, if a child always leaves their wet towel on the bathroom floor, then the child's parent may tap the child's name, may denote “Towel on floor”, and may potentially snap a picture. The child may be notified on their device of their “offense” with proof (e.g., the photo), along with an associated deduction of Karma points.

Alternatively, according to another exemplary embodiment, a child may perform an unassigned task, may document the tasks' completion (e.g., picture, voice note, etc.), and may submit it for potential Karma points. This may teach proactivity, an invaluable lifeskill.

Parents may say that “I shouldn't have to tell you everything.” But, with children, you may. Part of doing things right may include providing thorough instructions, which may include examples of what a good job looks like. A system, according to another exemplary embodiment, may allow uploading of instructions along with reference pictures. For younger children, tasks may be pictorial, such as, e.g., but not limited to, image, visual, and/or audio based content, etc., according to another exemplary embodiment. An example may include, according to another exemplary embodiment, showing a picture of how a bathroom sink should look when it is properly cleaned.

According to another exemplary embodiment, key steps may be highlighted, such as, but not limited to, “sink bowl wiped clean.” Parents and/or other assignors, may often be guilty of yelling “clean your room” without ever really teaching their child or other assignee how to do the task correctly.

According to another exemplary embodiment, a child (assignee) with the references in their hand, can meet and beat their parents' (assignor's) expectations.

According to another exemplary embodiment, parents and children can look at reports to see how they are doing (completion percentage, quality, pro-activeness, Repeat Offender trend, changes to Karma, etc.).

Ideally, the system, according to an exemplary embodiment, may further interact with other apps such as, but not limited to, family calendars (e.g. Cozi), iCal, location services, etc., to allow parents and children to plan the tasks with their activities in mind.

According to another exemplary embodiment, the system may take voice commands, via voice recognition software. According to another exemplary embodiment, via voice synthesis, the system may provide verbal step by step instructions entered by the assigning user when the performing user proceeds through an exemplary task list.

The system, according to another exemplary embodiment, may assume pervasive use of hand-held devices that run IOS or Android. For kids with basic mobile and text plans, they may be able to receive exemplary simple message system (SMS) text messages with tasks and may reply back with completed status, according to another exemplary embodiment. The ability to perform similar functions on a desktop, portable, mobile device, Mac, PC, thin client, fat client, ultrabook, and/or Netbook may be provided in an exemplary web browser and/or application, and/or applet, and/or app, according to another exemplary embodiment.

As noted, unlock codes, according to another exemplary embodiment, be able to be generated as part of an exemplary reward system. According to one exemplary embodiment, an exemplary separate, but potentially integrated and/or coupled technology (“PlugBug”) may be provided, which, according to another exemplary embodiment, may control the power to, e.g., but not limited to, an exemplary game console, computer, and/or other device, such as, e.g., but not limited to, any other electronically powered device such as, but not limited to, a TV, a computer, a radio, an electronic device, etc., as may be dictated by the EarnNow codes. The EarnNow codes, according to another exemplary embodiment, may expire when used. The code may be associated with an exemplary embedded algorithm that may tell the device how long to pass power. Ideally, the child's device may communicate with the power device to unlock codes and/or report time of play to the parents' device via at least one of: blue tooth, WIFI, and other wireless and/or wired communications links. According to one exemplary embodiment, an exemplary system may interface using industry standard wireless protocols including Zigbee protocol compliance based and enabled devices and/or bluetooth and/or WiFi and/or other wireless device communications technologies to permit access via application control to externally powered devices via exemplary interface devices.

According to another exemplary embodiment, EarnNow Karma Points may be essentially an alternative currency and can be, but is not limited to, traded, donated, redeemed and/or gifted between users. An exchange rate may be established by the parents to create value in the real world, according to another exemplary embodiment. Partnerships with online retail sites that kids frequent may provide incentives for children to use their reward points via exemplary “EarnNow” accounts on sites, such as, but not limited to, the iTunes store, Google Play, Amazon, an online savings account, and/or other ecommerce sites and/or application purchasing depots, etc.

According to another exemplary embodiment, EarnNow may ensure ‘no drama’, ‘no yelling’, and; or no trying to recall what was said or what was done. According to another exemplary embodiment, parents may assign tasks. According to another exemplary embodiment, children may complete the tasks. Good behavior may be rewarded while discipline may be tied to specific, clear expectations, according to another exemplary embodiment. Over times, good habits may be taught and reinforced while bad habits may systematically be eliminated, according to another exemplary embodiment. According to another exemplary embodiment, “spare this app” and “spoil the child!” commands may be utilized.

### DISCUSSION OF FIGURES

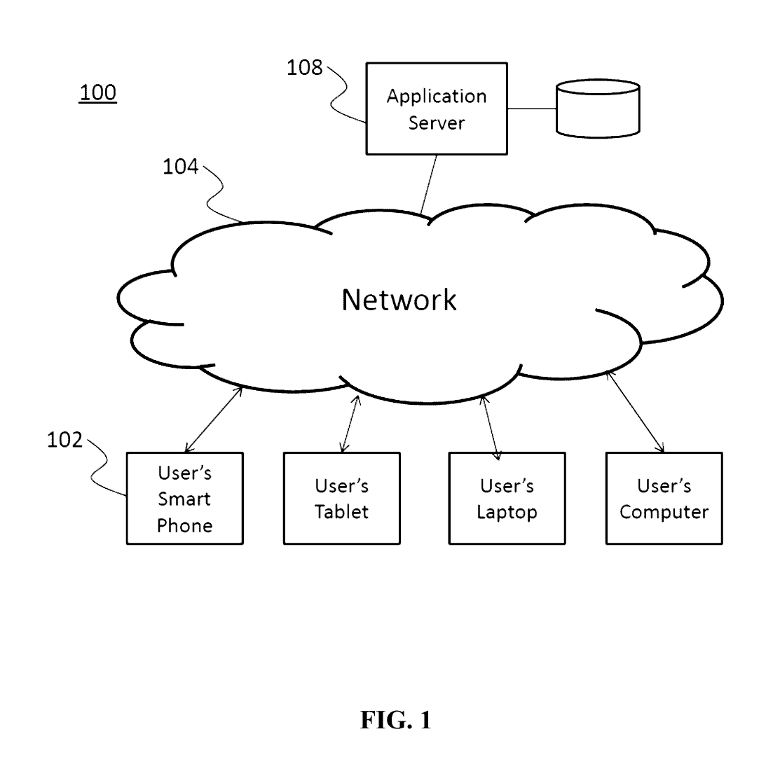

FIG. 1 depicts an exemplary embodiment of an exemplary heterogeneous client device environment coupled to an exemplary network system adapted to provide a network-based merit-based incentive to-do list system architecture environment including a plurality of computing and/or communication devices coupled together in a distributed networked system architecture 100.

An exemplary computer system platform executing an exemplary software application program, which may reside, for example, on an exemplary user's client computing and/or communications device 102 and/or on a server 108 in interactive communication over an exemplary network 104 with the user's client computing device 102 in a client/server, hierarchical, terminal server, or peer-to-peer fashion which may include, but is not limited to, a computing or communications device, desktop/laptop computers, tablet computers, personal digital assistants, telephony, smart-phone, mobile device, mobile phone, wireless device, tablet, personal digital assistant, handheld and the like, which may, in an exemplary embodiment, be the device capable of providing user display or other output and receiving input from user interactive selections via any of various well-known input devices for creation of task lists by assigning users (e.g., parents) and receipt of tasks, instructions, etc., by performing users through various ways via the user's computing device. According to an exemplary embodiment, various versions of the exemplary software program, which may be at least one of: an applet, an app, an iOS app, an Android app, a Windows 7/8/n+app, a standalone application program, a browser-based user interface, an Internet-browser-based interface, and a Java applet, among various other embodiments as will be apparent to those skilled in the art, and as discussed further below with reference to FIGS. 1-13, according to various exemplary embodiments.

In an exemplary embodiment, exemplary screen shots may be, but are not limited to browser-based interactive interfaces and an application or applet, such as a toolbar or browser based toolbar. In another exemplary embodiment, the toolbar may be an applet, or other application program that may be provided in any of various well-known ways, such as, but not limited to, an Internet browser-based toolbar, a JAVA applet, an ANDROID application, a Windows 7 or Windows 8, etc. application program, an iPOD, iPhone, or iPAD application, a MAC OS/X application, an iOS application, etc.

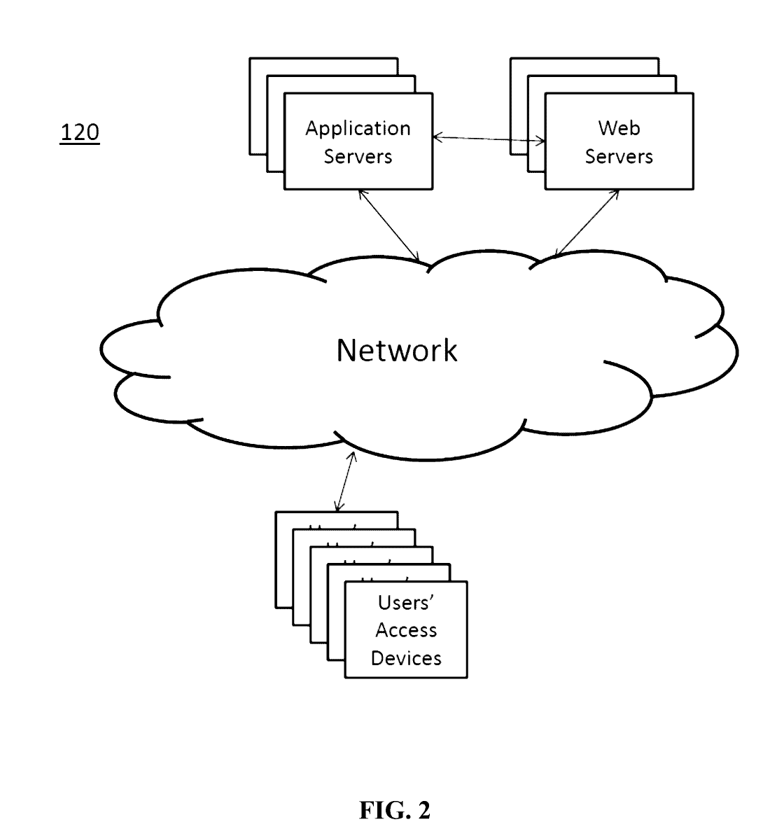

FIG. 2 depicts an exemplary embodiment of a network-based promotion system architecture high level diagram 120 coupled together by an exemplary cloud-based architecture network.

According to an exemplary embodiment, an exemplary cloud/network system and software, a remote client server topology, a world wide web based (WWW) internet browser based application, or the like application may be provided. Users as shown in diagram 120 may access applications, in an exemplary embodiment, via a network illustrated by the cloud, which may include, for example web servers such as, but not limited to, domain name servers (DNS) servers capable of domain name resolution, hypertext markup language (HTML), JAVA applications, and/or extensible markup language (XML) implemented interactive applications as a service offering may be implemented and may allow, e.g., but not limited to, interactive client to remote server device interaction in well-known matters via various well-known network protocols such as the internet protocol (IP) and the transmission control protocol (TCP), as well as any well-known network stack implementing the various communications layers of the OSI model for standard communication between two or more computing devices. According to an exemplary embodiment, many exemplary commercial cloud service providers may be used to host an application, if not a separate server one may use a cloud based offering such as, e.g., but not limited to, Amazon, Rackspace, Microsoft and/or many others as will be apparent to those skilled in the art, offering such capabilities, or alternatively application service providers (ASPs), software as a service (SAAS) provider, etc.

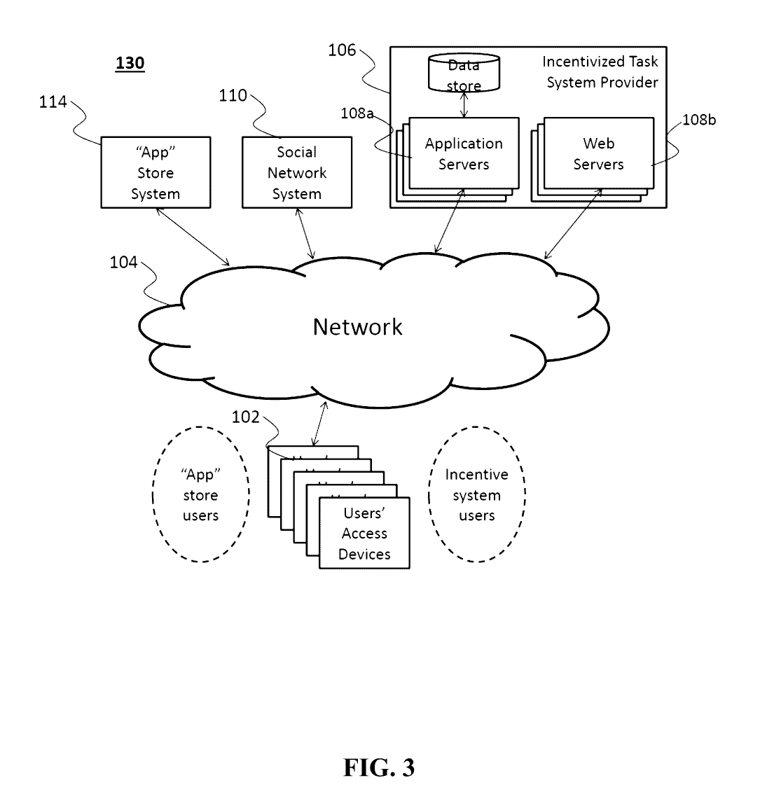

FIG. 3 depicts an exemplary embodiment of an exemplary system 130 illustrating an exemplary distributed network environment.

Diagram 130 of FIG. 3 illustrates exemplary social network user devices 102 a, 102 b (collectively referred to as 102, e.g., a personal computer (PC), or smartphone, among other devices as illustrated in FIG. 1 above, etc.) by which a user may access a network 104 to gain access to other network resources, according to an exemplary embodiment. According to an exemplary embodiment, the user device 102 may communicate via network 104 to other user devices 102 via any of various communications applications such as, but not limited to, electronic mail systems or a social network 110 as illustrated including social network service provider device 112 also coupled to network 104, according to an exemplary embodiment. According to various embodiments, the user devices 102 may also access an exemplary merit-based incentive system service provider 106, which as illustrated may include service provider user device 108 b as may be used to handle, e.g., tracking of tasks, Karma points, points system value, etc., processing financial transactions to, e.g., but not limited to, a bank and/or credit card service, etc. As shown, the user devices 102 may access the exemplary to-do list system and incentive system service provider 106, via, e.g., but not limited to, a browser-based internet application, illustrated via web server 108 a, which may perform such functions such as providing load balancing and/or security, and/or a firewall for the service provider 106, as well as serve access to one or more application servers, such as, but not limited to, a database management system such as, e.g., but not limited to, a relational database or other application software system, according to an exemplary embodiment. Further, as illustrated, other devices of users such as, e.g., but not limited to, application store devices, or other devices 116 a, 116 b (collectively 116), may be used to originally subscribe to the service provider's system, for app based embodiments, and may be downloaded onto the appropriate device, as discussed below, which when executed, may be used by an assigning user as illustrated in creating and assigning task items to a performing user's task list of tasks to be performed by the performing user using the exemplary system as disclosed to track completion of the tasks, track rewards earned, and/or redemption/fulfillment of rewards earned, according to various embodiments of the disclosure. For example, a parent (or other assignor) using an assigning user device 116 may use the exemplary system to create a list of tasks for the parent's child (or other assignee) to perform, in order to earn the child's allowance, or assignee's desired benefit, and the allowance/benefit may be redeemed in the form of Karma points (point system value), managed in an account tracked on the service provider's device, in one exemplary embodiment.

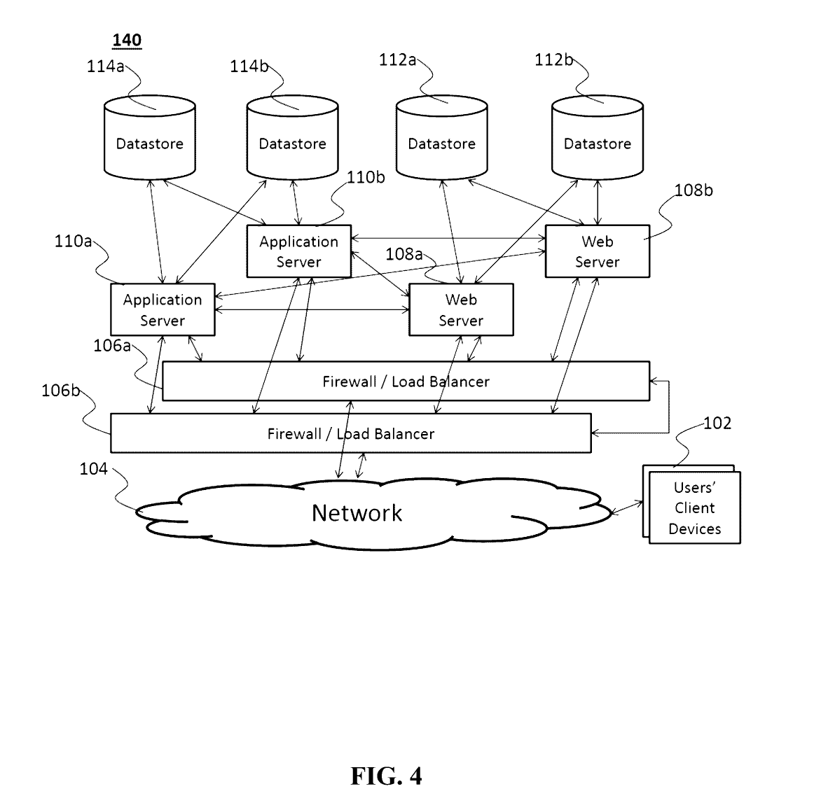

FIG. 4 depicts an exemplary embodiment of diagram 140 of an exemplary system illustrating an exemplary network environment. FIG. 4 illustrates an exemplary overview of an exemplary system as may be used in an exemplary environment according to various exemplary embodiments of the present disclosure. FIG. 1 depicts an exemplary embodiment of a high level system block diagram 140 that can be used to provide an exemplary system for providing a non-quantitative information search and response engine.

The high level system block diagram 140 of FIG. 4 may include, in an exemplary embodiment, users interacting with browsers on client devices 102 a, or 102 b (collectively 102), respectively. Browsers can be, e.g., but not limited to, application software programs executed on computer workstations or other computer processor based devices 102 (including mobile devices such as, e.g., but not limited to, communication devices, phones, smartphones, tablets, and/or computer tablets), which may be coupled via a network 104 (in wireline and/or wireless fashion) to other devices, as shown, in an exemplary embodiment. Workstations 102 can be coupled via a network 104 such as, e.g., but not limited to, an internet, and intranet, or another type of network. In an exemplary embodiment network 104 may include the global Internet. Network 104 may provide access for client devices 102 to gain access to, e.g., but not limited to, one or more application servers 110 a, 110 b (collectively 110), such as, e.g., but not limited to, a database management system (DBMS). Although a client server topology is discussed, any other various, well-known types of communication topologies may also be used such as, but not limited to, point-to-point, peer-to-peer, cloud-based, software as a service (SAAS), browser-based, hierarchical, distributed, and/or centralized, etc. The application server 110 can manage one or more databases (collectively 112). In an exemplary embodiment, the application server 120 can access an exemplary database(s) 114 having a plurality of data records, where in an exemplary embodiment, each data record may have one or more fields, etc. It will be apparent to those skilled in the art, that each database 112, 114 can be part of a larger database or can be broken into a plurality of separate subdatabases. In an exemplary embodiment of the present disclosure, search results can include a plurality of records obtained from the database 112, 114 that meet search criteria included in a search query. Network 104 may be coupled to any various well-known components such as, but not limited to, one or more load balancing devices or firewall devices 106 a, 106 b (collectively 106), web server(s) 108, application server(s) 110, routers, gateways, physical layer devices, data link layer devices, and/or network layer devices, etc.

As illustrated, web servers 108 and application servers 110 may be coupled to one another via one or more network(s) 104. Although network 104 is shown, in an exemplary embodiment, as being downstream of load balancing devices 106, it is also possible to have a network upstream of load balancing devices 104, coupling, e.g., but not limited to, application server(s) 110, web server(s) 108, and/or database(s) 112, 114, as well as other client or other server devices (not shown), local and/or remote from the depicted exemplary devices, etc. Exemplary client devices 102 are depicted downstream over an exemplary network(s) 104 from the server devices, but may be elsewhere in the network topology, e.g., inside, or outside a firewall. It is also important to note that network 104 may be represented in cloud metaphor schematic, but various well-known network devices including various well-known star-based, bus-based, or other well-known network topologies may also be represented by exemplary network(s) 104.

A user interacting with a browser on workstation 102 can access database 114 a, in an exemplary embodiment by traversing several intervening networks using well-known communications protocols such as, but not limited to, transmission control protocol/internet protocol (TCP/IP). Specifically, in an exemplary embodiment, workstation 102 a can be coupled via exemplary network(s) 104 including, e.g., but not limited to, a public and/or private network, and/or the global Internet to any of various exemplary website system(s), in this exemplary case, web server(s) 108 a, 108 b (collectively 108), which may include any of various hosting systems such as, e.g., but not limited to, a domain system, a domain name server (DNS), a domain controller system, etc. Website or webserver system 108 in an exemplary embodiment can be, e.g., but is not limited to, the EarnNow To-do list Merit-based Incentive and Rewards System Service Provider website available from EarnNow (EarnNow.com) of Austin, Tex. USA. The website system 110 can include, in an exemplary embodiment, an exemplary firewall 106 coupled to, or in addition to, or integrated with, a load balancer 106 a, 106 b (which could alternatively run on a general purpose computer such as, e.g., web server 108 a, 108 b, etc.). Load balancer 106 can be coupled to an exemplary web server 108 a, and 108 b. Web servers 108 a, 108 b can be coupled to one or more application servers 110 a, 110 b, via hardware and/or software system solutions, according to an exemplary embodiment, or via another network 104 (not shown). Each server 108, 110, may include, e.g., but is not limited to, or may not be coupled to, one or more database(s) 112, 114. Web server(s) 108 a, 108 b in an exemplary embodiment, can perform load balancing functions by transferring user application requests/queries to one or more of the application servers 110 a, 110 b. Results of the exemplary requests and/or queries from database 114 can be transferred from application servers 110 a, 110 b through web servers 108 a, 108 b through the network 104 to workstation 104.

The portal application program and/or links to the portal, may be integrated and/or embedded into other well-known collaborative, and/or social networking environments or applications such as, e.g., but not limited to, Facebook, LinkedIn, LotusLive, Microsoft Exchange/Sharepoint, GoogleTalk, GoogleVoice, Skype, Facetime, Google+, and/or video teleconferencing, Voxeo, SalesForce.com, CRM systems, etc., and/or other network environments, social media environments, communications environments, and/or collaborative environments.

Any illustration of exemplary fixed images, and/or exemplary arrangements of the exemplary portal is merely exemplary, but non-limiting, as video means, audio means, and/or a combination of audio/video streams and/or other content may also be used to enable efficient user interaction, according to various exemplary embodiments.

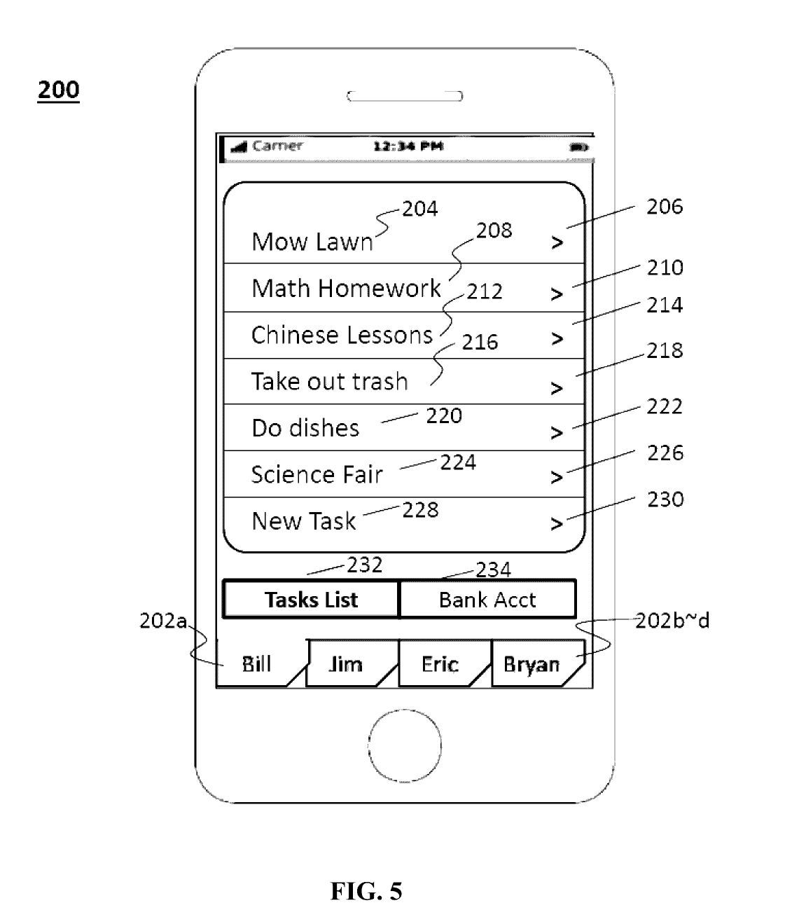

FIG. 5 depicts an exemplary embodiment of an exemplary screenshot of an exemplary user interface (UI) 200 illustrating an exemplary to-do list application program for managing and tracking an exemplary list of a plurality of tasks (e.g., previously assigned by an exemplary assigning user or assignor, e.g., but not limited to, a parent) to be performed by a performing user or assignee (e.g., but not limited to, a child, etc.).

FIG. 5 depicts an exemplary embodiment of a diagram 200 illustrating an exemplary user interface screenshot depicting an exemplary user interface of a performing user application. Various optional features for an exemplary application may be depicted, but need not necessarily be included in all embodiments. For example, diagram 200 may illustrate inclusion of an interactive user interface and may include one or more hyperlinks 202-210, illustrating an exemplary list of an exemplary one or more task items 202-210 as may have been previously assigned by an assigning user, to be performed by a performing user. The UI 200 may include various interface elements 202-332, including folder tabs 202 a, 202 b, 202 c, and 202 d (collectively 202), task list button 232, and bank 234. An exemplary list of tasks for an exemplary user include tasks 204, 208, 212, 216, 220, 224, and 228. According to an exemplary embodiment, further details about each task list item may be accessed by user interface elements 206, 210, 214, 218, 222, 226, or 230.

The application home interface page may include, in an exemplary embodiment, an exemplary image 214 of a given performing user and/or an exemplary image 216 of a given assigning user that may be depicted to remind the user of users for which a task is being performed. The exemplary environment may accommodate an exemplary consistent user experience across exemplary multiple platforms, which may permit a user to access the to-do-list application on a handheld and/or smartphone device, and/or via a browser-based Internet terminal, and/or via an applet based, and/or cloudbased and/or application service provider (ASP) based solution, and/or standalone computer applet based system.

According to one exemplary embodiment, a portal application program and/or links to the portal, may be integrated into and/or embedded other well-known collaborative environments and/or social media applications such as, e.g., but not limited to, LotusLive, Microsoft Exchange/Sharepoint, GoogleTalk, GoogleVoice, Skype, Facetime, Google+, Facebook, and/or video teleconferencing, Voxeo, SalesForce.com, CRM systems, etc., and/or other network environments, social media environments, communications environments, and/or collaborative environments. Thus, the illustration of exemplary fixed images, and/or exemplary arrangements of the exemplary portal is merely exemplary and nonlimiting as video means. An audio and/or a video stream and/or other content may also be used to assign tasks and/or manage reviewing, tracking, and completing performance of various tasks by the performing user, according to various exemplary embodiments.

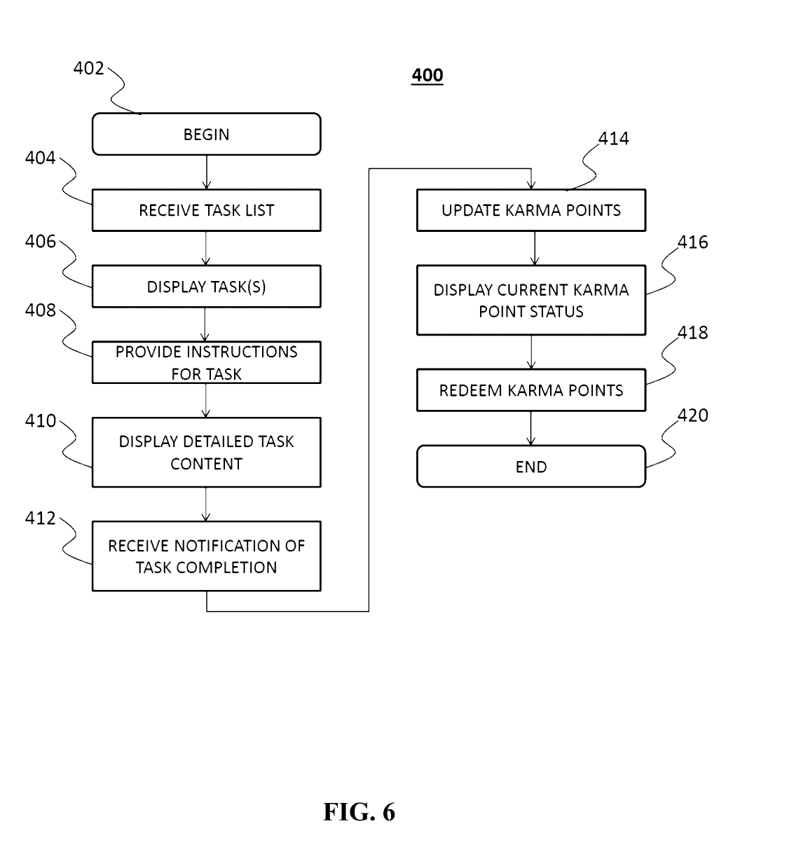

FIG. 6 depicts an exemplary flow diagram 400, according to an exemplary embodiment illustrating an exemplary process of managing performance of one or more tasks, assigned by an assigning user to a performing user, to be performed by the performing user.

Flow diagram 400 may begin as shown, in an exemplary embodiment with 402, and may continue immediately with 404.

In 404, a device of a performing user, such as, but not limited to, a child, according to one exemplary embodiment, may receive a task list. The computing device may accept the task list and display the list to the performing user for review and completion of actions.

From 404, the flow diagram 400 may continue with 406, in an exemplary embodiment.

In 406, the method may display one or more tasks to be completed by the performing user, i.e., the child. Then flow diagram 400 may continue with 408, in an exemplary embodiment.

In 408, the method may display content including, e.g., but not limited to, content captured relating to the tasks assigned. From this, flow diagram 400 may continue with 410, in an exemplary embodiment.

In 410, the method may provide instructions to the child instructing how to complete the task item and then flow diagram 400 may continue with 412, in an exemplary embodiment.

According to an exemplary embodiment, the computing device may next, beginning with exemplary elements 412-418, receive various exemplary Karma point related transactions.

In 412, the computing device may receive an indication from the performing user, of completion of the task. From 412, flow diagram 400 may continue with 414, in an exemplary embodiment.

In 414, the computing device may receive and update (and/or store) a value for the Karma points earned from completion of the task, by the assigning the currency value, in association with an identifier for the given performing user. From 414, flow diagram 400 may continue with 416, in an exemplary embodiment.

In 416, the computing device may provide and/or display (and/or store) the current Karma point status for a given performing user. From 416, flow diagram 400 may continue with 418.

In 418, the computing device may receive a request to redeem Karma points (and/or store), and may process the request. From 418, flow diagram 400 may continue with 420 and may immediately end, according to one exemplary embodiment.

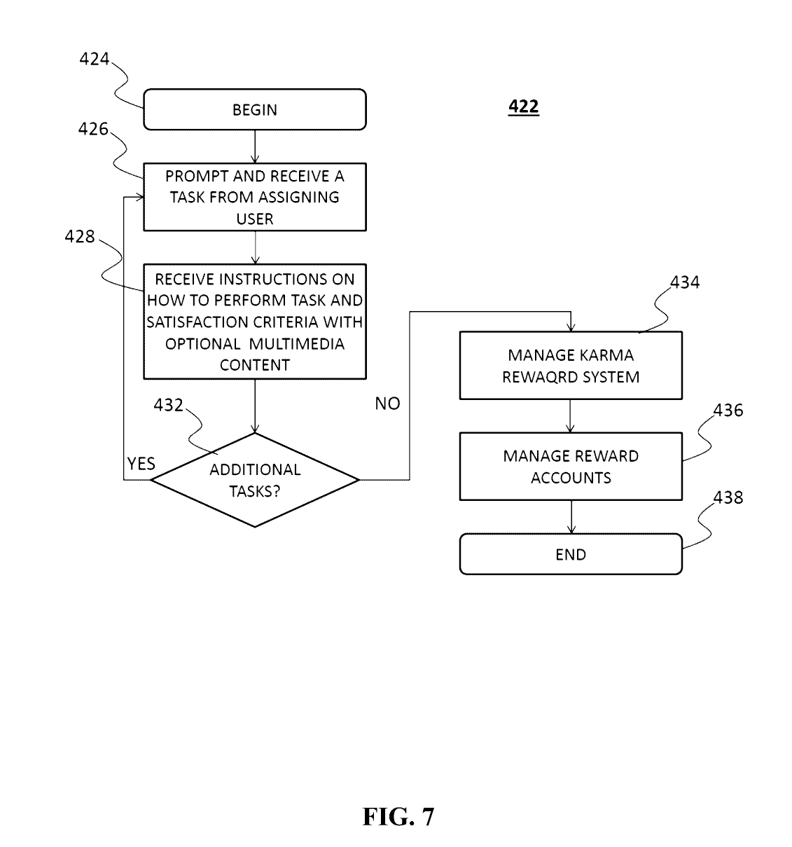

FIG. 7 depicts an exemplary flow diagram 422, according to an exemplary embodiment illustrating an exemplary process of receiving assignment of task elements to a task list for completion by a performing user as described above in FIG. 6 for a first customer user and for initializing and creating the task list.

Flow diagram 422 may begin as shown with 424, and may continue immediately with 426, in an exemplary embodiment.

In 426 a computing device may prompt and receive in response, a task from an assigning user, to assigning a task for a performing user, created by the process 400 described with reference to FIG. 6 above. According to an exemplary embodiment, the task list generator may be used by an assigning user to generate a thread. From 426, flow diagram 422 may continue with 428.

In 428, the computing device may receive (and/or store) instructions on how to perform the task. From 428, flow diagram 422 may continue with 430, in an exemplary embodiment.

In 430, the computing device may initialize a task, and may receive and instructions on how to perform the task. From 430, flow diagram 430 may continue with 432.

In 432, it may be determined by the computing device whether there are additional tasks to perform. From 432, flow diagram 422 may continue with 426 in the case of additional, and if there are no more tasks to be performed, then flow diagram 422 may continue with 434.

In 434, the computing device may manage the karma reward system. From 434, flow diagram 422 may continue with 436.

In 436, the computing device may manage reward accounts. From 436, in an exemplary embodiment, flow diagram 422 may continue with 438, and flow diagram 422 may continue immediately by ending with 438, in an exemplary embodiment.

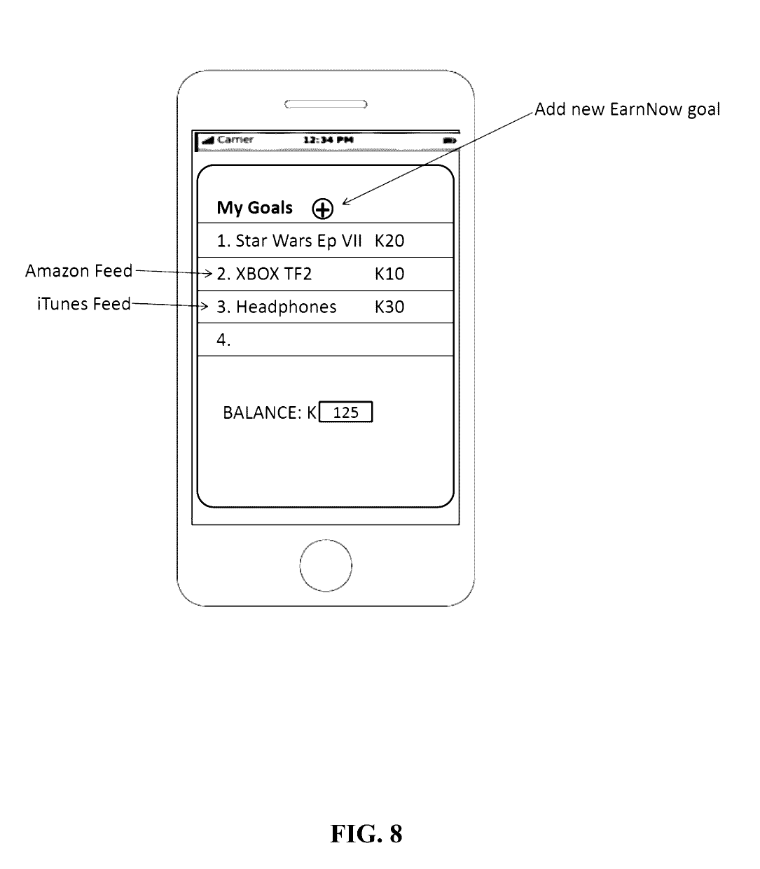

FIG. 8 depicts a wireframe diagram of an exemplary user interface (UI) illustrating an exemplary application program for among other things displaying an exemplary current balance of points for an exemplary points value system; and display of exemplary goals, etc.

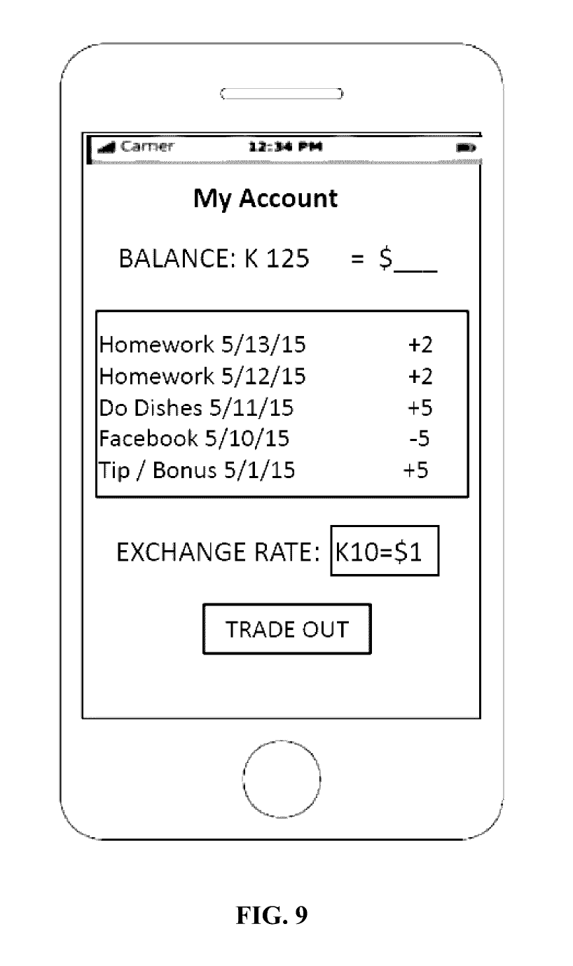

FIG. 9 depicts a wireframe diagram of an exemplary user interface (UI) illustrating an exemplary application program for displaying an exemplary current balance of points for an exemplary points value system. The exemplary user interface (UI) may include an exemplary interface for viewing exemplary transactions for positive and negative point values totaling to that balance of points and exemplary functionality to convert point system value into, e.g., exemplary monetary value, etc.

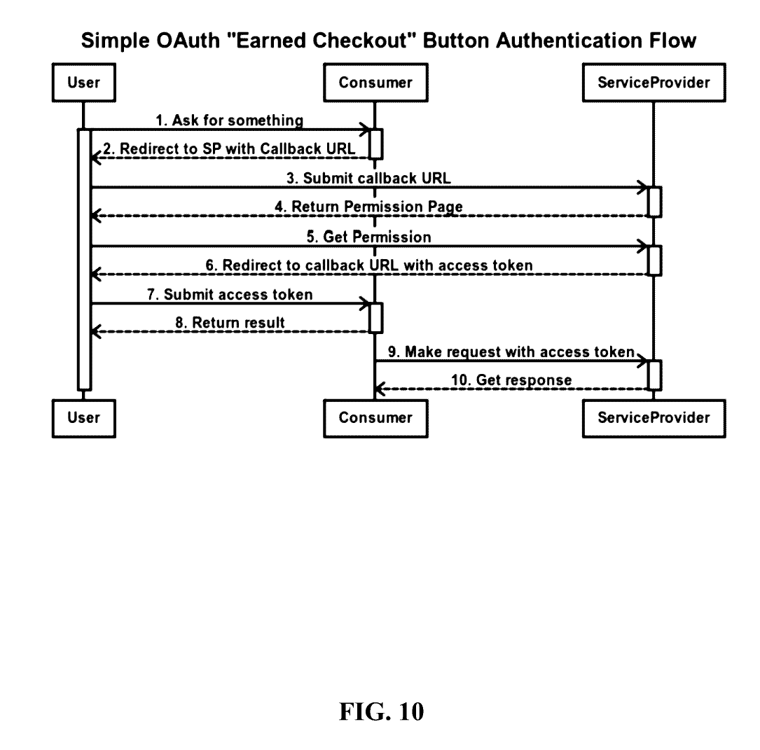

FIG. 10 depicts a sequence diagram of a messaging flow between an exemplary user of the system that may provide shopping at an exemplary online retailer (in the figure, “Consumer” of “EarnNow” system), the retailer (“Consumer”) and the exemplary “EarnNow” service provider. The user may click on the exemplary “EarnNow” button on the online retailer partner's shopping cart checkout page, or by pressing a button provided by an “EarnNow” browser plugin or an “EarnNow” mobile app, triggering the need for authentication of user to the EarnNow system, and validation of that verification back to the retailer, plugin, or mobile app. When the button is pressed, a message (1) is sent to the retailer, which responds with a redirect link (URL) to the Service Provider (2). The user's browser may automatically request the service provider's login page (3). The Service Provider may respond with the login page (4). The consumer may enter in appropriate credentials (username/password or some multi-factor authentication (5). The service provider may (if valid) respond with the retailer's provided (in 2,3) callback URL and a validation token (6). The consumer's browser may automatically request that callback URL at the retailer together with the validation token (7). If valid, the retailer may respond with the response to the original request (“EarnNow button request”) (8). In embodiments, the retailer may know how to directly decode the encrypted validation tokens. In other embodiments, the retailer will need to forward the token to the service provider for verification (9,10).

The view of the flow as presented by the user's browser may be subtle. In embodiments, interactions between 1 and 8 may be contained within an iframe embedded within a retailer checkout page. In embodiments, the user may press a button, may be presented a small form for entering the exemplary system credentials to submit, and may be directed to a page where the operation is displayed as having been completed.

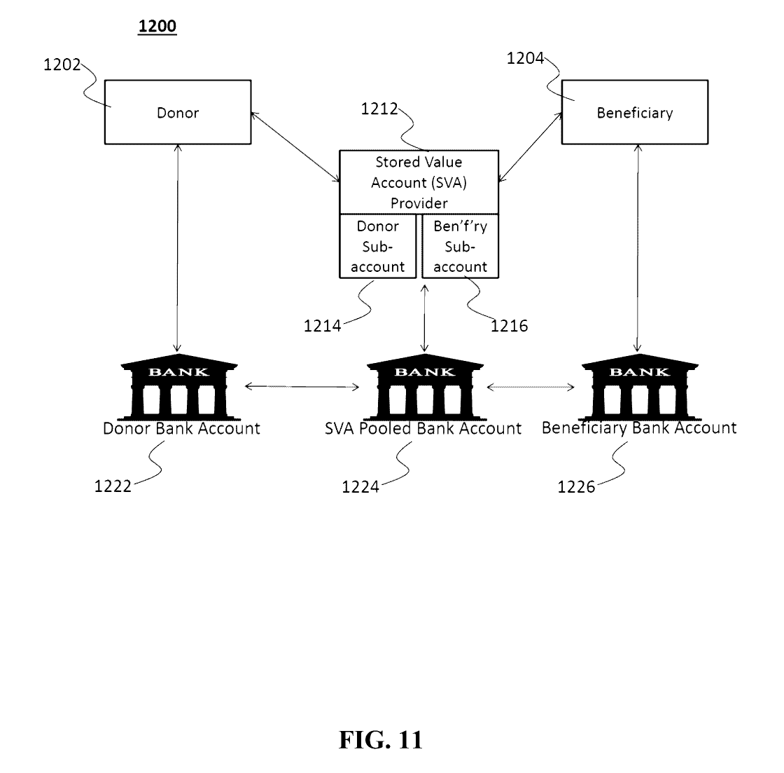

FIG. 11 depicts a diagram 1200 of the major entities in an exemplary embodiment of a stored value account (“SVA”) funds transfer system. There may be a Donor 1202 with a bank account 1222. There may be a Beneficiary 1204, with his own respective bank account 1226. Each may have accounts 1214, 1216 with the same SVA Service provider as each other 1212 that may be provided by a service provider or through a partnership with a correspondent bank group or an Internet SVA provider such as, but not limited to, PayPal™. The SVA service provider may have an account with a bank 1224 which may hold the pooled fund balances of all SVA service provider accounts.

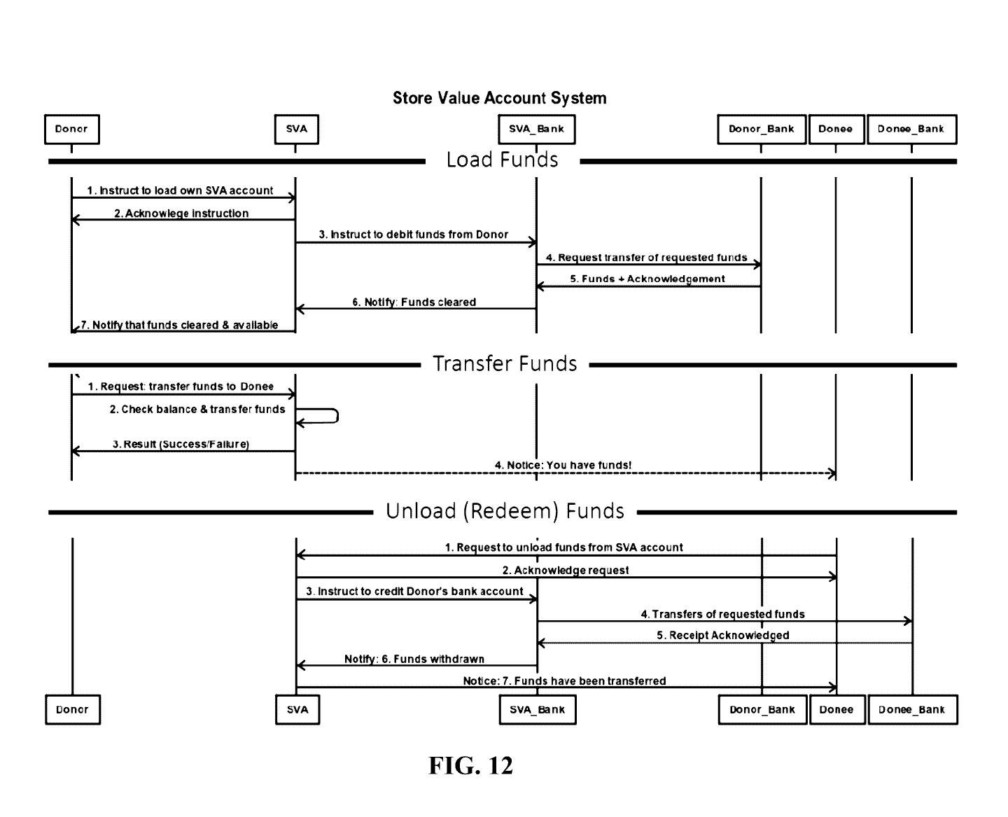

FIG. 12 depicts an sequence diagram of communications between the entities in FIG. 11 for three major exemplary transaction types: loading an SVA account with funds from a bank account, unloading some funds from the SVA into a bank account, and transferring funds between two SVA Accounts.

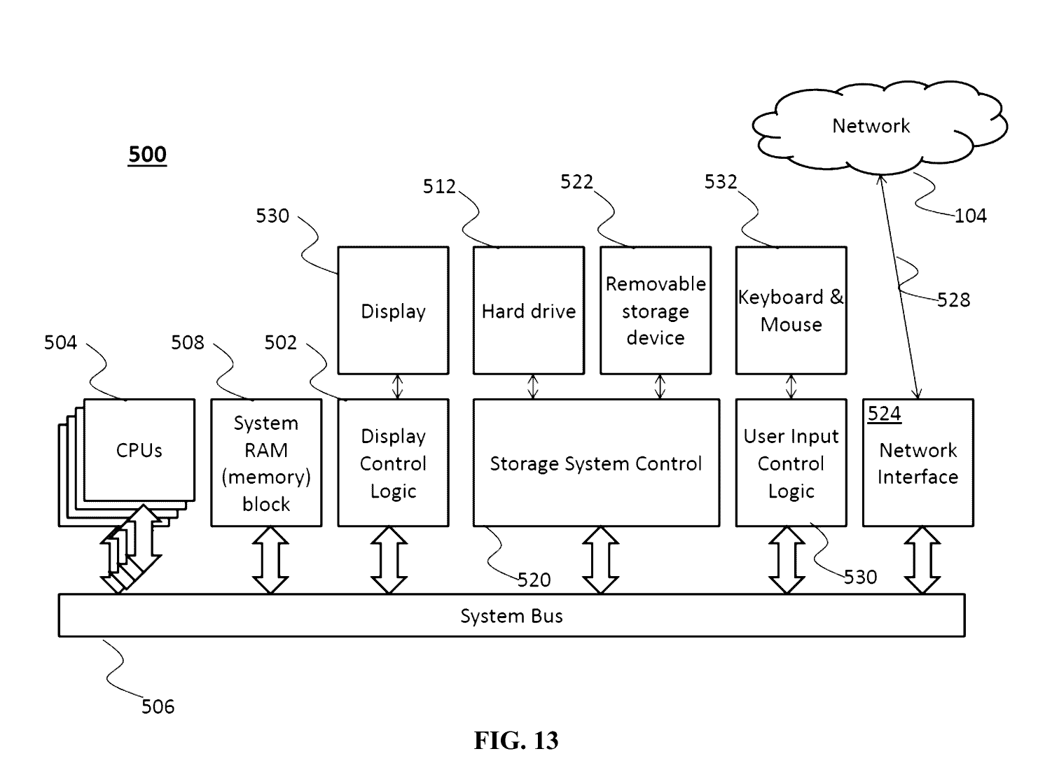

FIG. 13 depicts an exemplary diagram 500 illustrating an exemplary computer/communications device hardware architecture as may be used in various components of the disclosure. FIG. 13 depicts an exemplary diagram 500 illustrating an exemplary computer/communications device hardware architecture as may be used in various components of the disclosure. FIG. 13 depicts an exemplary computing system 500 as may be used in implementing an exemplary embodiment of the disclosure. FIG. 13 depicts an exemplary embodiment of a computing system 500 that may be used in computing devices such as, e.g., but not limited to, user devices 102, 102 a, 102 b, promotions service provide device 108, 108 a, 108 b, and/or web server 108 a and/or application server 108 b, social network computing device(s) 112 of social network 110, vendor user devices 116, 116 a, 116 b and 114, network components 104, etc. FIG. 13 depicts an exemplary embodiment of a computing system 500 that may be used as client device 108, or a server device (not shown), etc. The disclosure (or any part(s) or function(s) thereof) may be implemented using hardware, software, firmware, or a combination thereof and may be implemented in one or more computer systems or other processing systems. In one exemplary embodiment, the disclosure may be directed toward one or more computer systems capable of carrying out the functionality described herein. An example of a computing system 500 is shown in FIG. 13 depicting an exemplary embodiment of a block diagram of an exemplary computer system useful for implementing the present disclosure. Specifically, FIG. 13 illustrates an example computer 500, which, in an exemplary embodiment may be, but is not limited to, a personal computer (PC) system running an operating system such as, but not limited to, WINDOWS MOBILE™ for POCKET PC, or MICROSOFT® WINDOWS® NT/98/2000/XP/CE/7/8 . . . , etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y., U.S.A, Mac/OS, OS/X, iOS from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc. However, the disclosure may not be limited to these platforms. The disclosure may be implemented on any computer system running any operating system. In one exemplary embodiment, the disclosure may be implemented on a computing system operating as discussed herein. An exemplary computing system, computer 500 may be shown in FIG. 13. Other components of the disclosure, such as, but not limited to, a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPod, an iPhone, a smartphone, an iPad, a tablet based device, a smart phone, an ANDROID OS device, an iOS device, a Symbian based device, a Windows 8 device, etc., may also be implemented using a computer such as that shown in FIG. 13.

The computing system 500 may include one or more processors, such as, but not limited to, processor(s) 504. The processor(s) 504 may be connected to a communication infrastructure 506 including, but not limited to, a communications bus, cross-over bar, or network, etc. Exemplary software embodiments may be described in terms of this exemplary computer system. After reading this description, it may be apparent to a person skilled in the relevant art(s) how to implement the disclosure using other computer systems and/or architectures.

Computing system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, but is not limited to, a main memory 508, random access memory (RAM), and a secondary memory 510, etc. The secondary memory 510 may include, for example, (but not limited to) a hard disk drive 512 and/or a removable storage drive 514, a floppy diskette drive, a magnetic tape drive, an optical disk drive, a compact disk drive CD-ROM, etc. The removable storage drive 514 may be, e.g., but is not limited to, read from and/or write to a removable storage unit 518 in a well-known manner. Removable storage unit 518, also called a program storage may represent at least one of: a floppy disk, magnetic tape, optical disk, compact disk, etc., which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, but not limited to, those found in video game devices), a removable memory chip (such as, but not limited to, an erasable programmable read only memory (EPROM), programmable read only memory (PROM) and associated socket, and other removable storage units 522 and interfaces 520), which may allow software and data to be transferred from the removable storage unit 522 to computer system 500.

Computer 500 may also include an input device such as, but not limited to, a mouse or other pointing device such as a digitizer, a keyboard, and other data entry device (none of which are labeled).

Computer 500 may also include output devices, such as, but not limited to, display 530, and display interface 502. Computer 500 may include input/output (I/O) devices such as, but not limited to, communications interface 524, cable 528, and communications path 526, etc. These devices may include, but are not limited to, a network interface card and modems (neither are labeled). Communications interface 524 may allow software and data to be transferred between computer system 500 and external devices. Examples of communications interfaces 524 may include, but are not limited to, a modem, a network interface (such as, e.g., an Ethernet card), a communications port, a Personal Computer Memory Card International Association (PCMCIA) slot, PC Card, SDRAM, universal serial bus (USB), solid state device (SSD) and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but is not limited to, a communications path 526 (e.g., but is not limited to, a channel). This channel 526 may carry signals 528, which may include, but is not limited to, propagated signals and may be implemented using, e.g., but not limited to, wire, cable, fiber optics, a telephone line, a cellular link, a radio frequency (RF) link, and other communications channels, etc.

In this document, the terms “computer program medium” and “computer readable medium” may be used to generally refer to media such as, but not limited to, removable storage drive 514, a hard disk installed in hard disk drive 512, and signals 528, etc. These computer program products may provide software to computer system 500. The disclosure may be directed to such computer program products.

References to “one embodiment,” “an embodiment,” “example embodiment,” “various embodiments,” etc., may indicate that the embodiment(s) of the disclosure so described may include a particular feature, structure, or characteristic, but not every embodiment necessarily includes the particular feature, structure, or characteristic.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These may include physical manipulations of physical quantities. Usually, though not necessarily, these quantities may take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It may be understood, however, that all of these and similar terms are to be associated with the appropriate physical quantities and may be merely convenient labels applied to these quantities.

Unless specifically stated otherwise, as apparent from the following discussions, it is appreciated that throughout the specification discussions utilizing terms such as “processing,” “computing,” “calculating,” “determining,” or the like, may refer to the action and/or process of a computer or computing system, or similar electronic computing device, that may manipulate and/or transform data represented as physical, such as electronic, quantities within the computing system's registers and/or memories into other data similarly represented as physical quantities within the computing system's memories, registers or other such information storage, transmission, or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments may include apparatuses for performing the operations herein. An apparatus may be specially constructed for the desired purposes, or it may comprise a general purpose device selectively activated or reconfigured by a program stored in the apparatus.

Embodiments of the disclosure may be implemented in one or a combination of hardware, firmware, and software. Embodiments of the disclosure may also be implemented as instructions stored on a machine-readable medium that may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the disclosure as discussed herein. In particular, the computer programs, when executed, may enable the processor 504 to provide a method to resolve conflicts during data synchronization according to an exemplary embodiment of the disclosure.

Accordingly, such computer programs may represent controllers of the computer system 500.

In another exemplary embodiment, the disclosure may be directed to a computer program product comprising a computer readable medium having control logic (computer software) stored thereon. The control logic, when executed by the processor 504, may cause the processor 504 to perform the functions of the system as described herein. In another exemplary embodiment where the disclosure may be implemented using software, the software may be stored as a computer program product and loaded into computing system 500 using, e.g., but not limited to, removable storage drive 514, hard drive 512 or communications interface 524, etc. The control logic (software), when executed by the processor 504, may cause the processor 504 to perform the functions of the system as described herein. The computer software may run as a standalone software application program running atop an operating system, or may be integrated into the operating system.

In yet another embodiment, the disclosure may be implemented primarily in hardware using, for example, but not limited to, hardware components such as application specific integrated circuits (ASICs), or one or more state machines, etc. Implementation of the hardware state machine to perform the functions described herein may be apparent to persons skilled in the relevant art(s).

In an exemplary embodiment, the disclosure may be implemented primarily in firmware.

In an exemplary embodiment, the disclosure may be implemented using a combination of any of, e.g., but not limited to, hardware, firmware, software, etc.

Exemplary embodiments of the disclosure may also be implemented as instructions stored on a machine-readable medium that may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

An exemplary embodiment of the present disclosure may make reference to wired or wireless networks. Wired networks include any of a wide variety of well-known means for coupling voice and data communications devices together. A brief discussion of various exemplary wireless network technologies that may be used to implement the embodiments of the disclosure now are discussed. The examples may be non-limited. Exemplary wireless network types may include, but are not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), ultrawideband (UWB), etc.

Bluetooth is a wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

Exemplary embodiments of the disclosure may make reference to WLANs. Examples of a WLAN may include a shared wireless access protocol (SWAP) developed by Home radio frequency (HomeRF) and wireless fidelity (Wi-Fi), a derivative of IEEE 802.11, advocated by the wireless ethernet compatibility alliance (WECA). The IEEE 802.11 wireless LAN standard may refer to various technologies that adhere to one or more of various wireless LAN standards. An IEEE 802.11 compliant wireless LAN may comply with any of one or more of the various IEEE 802.11 wireless LAN standards including, but not limited to, wireless LANs compliant with IEEE std. 802.11a, b, d or g, such as, but not limited to, IEEE std. 802.11a, b, d and g, (including, but not limited to IEEE 802.11g-2003, etc.), etc.

According to one exemplary embodiment, a child may be hired as a pet sitter for a week while a neighbor is on vacation. The neighbor (an exemplary assignor) can log on and assign specific tasks (e.g., but not limited to, feeding, walking, clean up, and/or meds, etc.) to an exemplary assignee with exemplary task fields such as, but not limited to, instructions, exemplary deadlines, exemplary periodicity, points (and/or cash) and/or emergency contact info (e.g., but not limited to, vet phone number, owner's vacation hotel number, etc). See QR codes and/or other sensed information such as, but not limited to, MEMS sensor data, location sensing data, bar code, QR Code, RFID tag, sensor data, etc. below, may be an exemplary way of capturing, actively and/or passively, an indication of initiation and/or completion of a given task, etc.

According to another exemplary embodiment, an exemplary system may include features including enabling user interactive selectability of prioritization of tasks to be accomplished such that an assignor can designate one task to be done before another (for example), or provide a measure of relative importance and/or higher value ranking, etc.

According to another exemplary embodiment, an exemplary system may include features including a task that is accomplished before a deadline (based on time stamp) that may be modified with bonus Karma points and if completed late may reduce the base Karma points.

According to another exemplary embodiment, an exemplary system may include features including both the “how” and the “how well” assessment (e.g., proof of accomplishment (initiation and/or completion), and/or assignors assessment of the task, etc.).

According to another exemplary embodiment, an exemplary system may include features including providing a system that may enable interacting with or receiving codes (e.g., bar code scan, QR code, a multiple dimension barcode, a scan, image, recognized sound, MEMS sensor data, radio frequency identifier (RFID) tag, and/or other indications associated with a task and/or its completion and/or initiation). Exemplary QR codes (and the ability to print QR codes) distributed by the system may be provided including, but not limited to, an exemplary assignor may add an exemplary QR code scan requirement to “brush teeth.” The exemplary code may be created within the system and the assignor may print the exemplary code on a label which may be affixed in the vicinity to the exemplary assignee's sink (and/or ordered and/or provided from an exemplary system and/or other store which may, send an exemplary laminated version with an exemplary adhesive back). When the exemplary assignee may brush the assignee's teeth, the assignee may have to scan the associated QR code. According to another exemplary embodiment, a feature may capture the time, task an interesting timer (two minutes with cool music) and location. Maybe it kicks off a recording by the smart phone, a sample recording of which may be available for review, auditing (the rest of the videos may be “dumped” but the assignee doesn't know which ones are available for audit!). Additional examples may include providing for placement of QR codes on garbage and recycling receptacles. The assignor may create exemplary codes for each location in a vicinity where a task is to be performed, (e.g., a receptacle). The task may, according to an exemplary embodiment, may be kicked off, initiated, or completed, by assignee and/or date/time, etc. The assignee may scan the first receptacle which may kick off, initiate, or mark complete, etc., the exemplary task details, points available, instructions and/or list of other receptacles needing service. Another example (see pet sitter above) may include when an exemplary assignee may be given a task by an exemplary outside and/or third party to do an exemplary task. An exemplary QR code or other code or sensor indication may be, or could be affixed by an exemplary 3rd party to a given device and/or apparatus to ensure that the exemplary assignee is at a house within the prescribed time frame. Exemplary pictures may be required to show feeding. Exemplary location based sensing, triangulating, and/or global positioning system (GPS) enabled location sensing may help determine, exemplary passive indications of task initiation and/or completion, e.g., an exemplary walking distance of dogs, etc.

According to another exemplary embodiment, an exemplary system may include features including an exemplary MEMs type sensor technology. An exemplary embodiment may include exemplary sensor integration with system enabling passive detection of task initiation, progress, completion, etc.

According to an exemplary embodiment, exemplary commercial service systems may show that requiring an exemplary technician to self-report (e.g., perform data entry) often may mean that the technician may be more apt to not using the system, or may be found to be ignoring the system. Data collected may suffer if exemplary systems require active participation (and techs wanted to fix stuff, not do data entry). According to one exemplary embodiment, the things associated with a task, and/or tasks that the assignee may have including, but not limited to, working on an exemplary technology to report exemplary tasks and/or activity (e.g., passive collection, etc.) then much more data may be collected. According to an exemplary embodiment, a dog bowl or a garbage may have a MEMs type sensor. Exemplary near field technology may enable exemplary connection with the smart device (e.g., iPhone, Android, MSFT OS, etc.) to connect which assignee (e.g., child and/or employee or other assignee, etc.)) may have performed the task (e.g., an exemplary accelerometer may show the exemplary emptying of the exemplary can or the refill of water for dogs). Another exemplary feature may be less than an exemplary improvement that the MEMs may tell the assignee(s) that a task is available based on the condition, e.g. the trash is full (based on weight), etc. The exemplary task may go to an exemplary queue that may be visible to, e.g., all possible assignees with an exemplary associated point value, etc., according to an exemplary embodiment.

The exemplary first assignee to complete the task may get the points, according to one exemplary embodiment.

According to an exemplary embodiment, a system may include features including enabling and/or facilitating communication in and amongst a community of earners that can share their tasks, how-to media training, and/or task initiation and/or completion, exemplary point systems and/or other ideas. We have an exemplary third party access, which according to an exemplary embodiment, may include an exemplary community access. According to one exemplary embodiment, features to allow exemplary community communication and/or social media discussions, may be provided, whereby an assignor may share any and/or all, etc., aspects of their earnings profile to include an exemplary task, exemplary how-to media (videos, task descriptions, dollar ratios/values relative to merit designated for a task, repeat offenders, etc.).

According to one exemplary embodiment, exemplary fellow earners may rate the profiles of others.

For the purposes of this disclosure, the terms “EarnNow system”, “EarnNow”, and “system” may be synonymous.

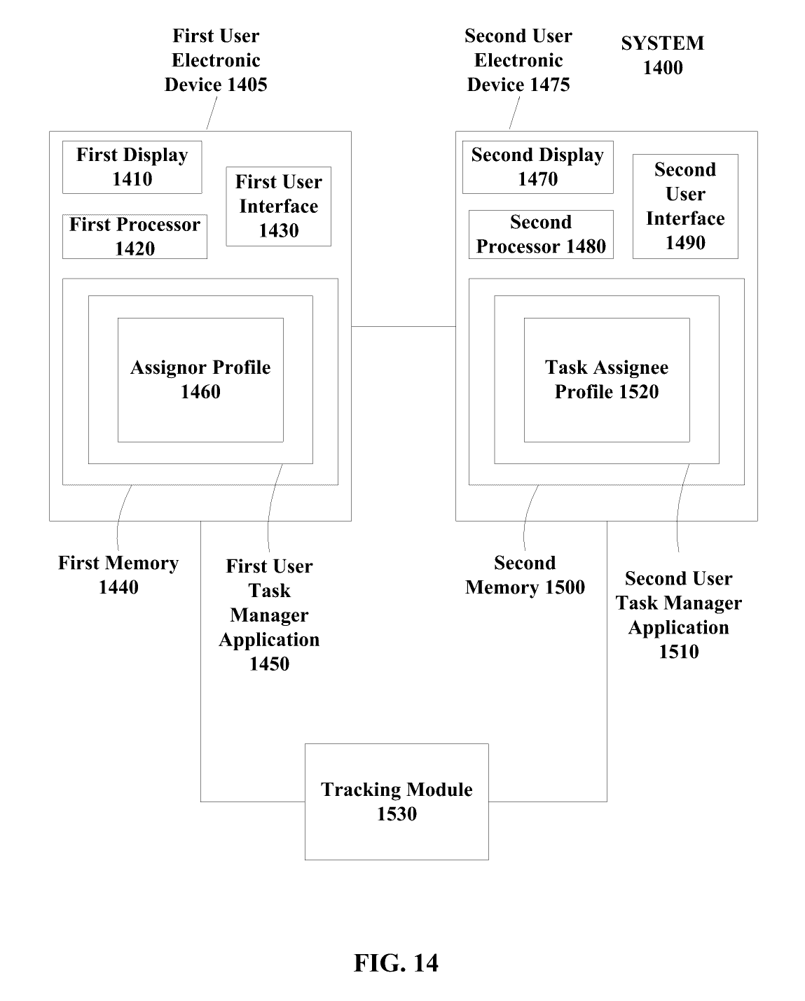

The disclosure may additionally provide a system 1400 for managing a plurality of assignable tasks, which may be depicted in FIG. 14. Each of the plurality of assignable tasks may be assigned by at least one assignor to be performed by at least one task assignee. System 1400 may comprise a first user electronic device 1405. The first user electronic device 1405 may include a first display 1410, a first processor 1420, a first memory 1440, and a first user interface 1430.

The first memory 1440 may include a first user task manager application 1450 which may provide the plurality of assignable tasks. The first user task manager application 1450 may comprise an assignor profile 1460. The first user interface 1430 may provide a plurality of assignable tasks, which may be assignable to a second user electronic device 1470. The first user interface 1430 may provide at least one numerical value corresponding to each one of the plurality of assignable tasks.

The second user electronic device 1470 may include a second display 1480, a second processor 1480, a second memory 1500, and a second user interface 1490.

The second memory 1500 may comprise a second user task manager application 1510 configured to receive the plurality of assignable tasks. The second user task manager application 1510 may comprise a task assignee profile 1520. The second user interface 1490 may provide the plurality of assignable tasks.

A tracking module 1530 may be stored on at least one of the first and the second memory 1440,1500 and may be configured to measure a completion indicator of each of the plurality of assignable tasks. The completion indicator may be provided on at least one of the first user interface 1430 and the second user interface 1490.

At least one of the first processor 1420 and the second processor 1480 may have a configuration adapted to assign at least one numerical value to at least one of the assignor profile 1460 and the task assignee profile 1520 responsive to a completion percentage specified for each of the plurality of assignable tasks.

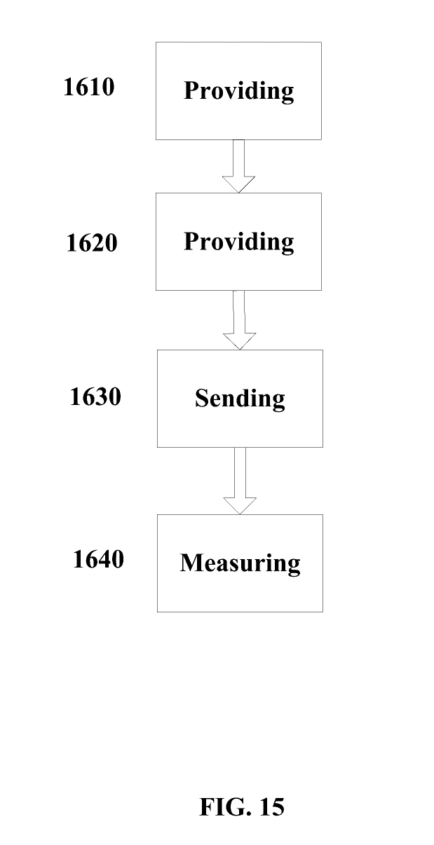

FIG. 15 displays a computer implemented method 1600 for managing a plurality of assignable tasks in accordance with embodiments. The method may comprise providing 1610 a first user electronic device 1405 including a first processor 1420, a first display 1410, and a first memory 1440. The first memory 1440 may comprise a first user task manager application 1450 including an assignor profile 1460.

A second user electronic device 1475 may be provided 1620 and may comprise a second processor 1480, a second display 1470, and a second memory 1500. The second memory 1500 may comprise a second user task manager application 1510 comprising a task assignee profile 1520.

The plurality of assignable tasks may be sent 1630 from a memory 1440 of the first user electronic device 1405 to a memory 1500 of the second user electronic device 1475. A completion portion of each of the plurality of assignable tasks may be measured 1640 via a tracking module 1530 stored on at least one of the first and the second memory 1440,1500.

At least one of the first processor 1420 and the second processor 1480 may have a configuration adapted to assign at least one numerical value to at least one of the assignor profile 1460 and the task assignee profile 1520. The assigning of the at least one numerical value may be performed responsive to a completion percentage specified for each of the plurality of assignable tasks.

While various embodiments of the present invention have been described above, it should be understood that they have been presented by way of example only, and not limitation.

Thus, the breadth and scope of the present invention should not be limited by any of the above described exemplary embodiments, but should instead be defined only in accordance with the following claims and their equivalents.

1. A system for managing a plurality of assignable tasks, each of the plurality of assignable tasks assigned by at least one assignor to be performed by at least one task assignee, the system comprising:
a first user electronic device including:
a first display;
a first processor;
a first memory comprising a first user task manager application, the first user task manager application providing the plurality of assignable tasks, the first user task manager application comprising an assignor profile;
a first user interface providing a plurality of assignable tasks, the plurality of assignable tasks being assignable to a second user electronic device, the first user interface providing at least one numerical value corresponding to each one of the plurality of assignable tasks;
the second user electronic device including:
a second display;
a second processor;
a second memory comprising a second user task manager application, the second user task manager application configured to receive the plurality of assignable tasks, the second user task manager application comprising a task assignee profile;
a second user interface providing the plurality of assignable tasks; and
a tracking module stored on at least one of the first and the second memory, the tracking module configured to measure a completion indicator of each of the plurality of assignable tasks, the completion indicator provided on at least one of the first user interface and the second user interface;
wherein at least one of the first processor and the second processor has a configuration adapted to assign at least one numerical value to at least one of the assignor profile and the task assignee profile responsive to a completion percentage specified for each of the plurality of assignable tasks.

2. A computer implemented method for managing a plurality of assignable tasks, the method comprising:
providing a first user electronic device comprising a first processor, a first display, and a first memory, the first memory comprising a first user task manager application, the first user task manager application comprising an assignor profile;
providing a second user electronic device comprising a second processor, a second display, and a second memory, the second memory comprising a second user task manager application, the second user task manager application comprising an assignee profile;
sending, from a memory of the first user electronic device to a memory of the second user electronic device, the plurality of assignable tasks;
measuring a completion portion of each of the plurality of assignable tasks via a tracking module stored on at least one of the first and the second memory;
wherein at least one of the first processor and the second processor has a configuration adapted to assign at least one numerical value to at least one of the assignor profile and the task assignee profile, the assigning of the at least one numerical value performed responsive to a completion percentage specified for each of the plurality of assignable tasks.
